(19) United States
(12) Patent Application Publication
(10) Pub. No.: US 2026/0184882 A1
(43) Pub. Date: Jul. 2, 2026

(54) METHOD FOR SEPARATING COMPONENTS OF MIXED TEXTILE FEEDSTOCK FOR RECYCLING

(71) Applicant: International Business Machines Corporation, Armonk, NY (US)

(72) Inventors: Gregory Breyta, San Jose, CA (US); Ting-Han Lee, San Jose, CA (US); Joseph Hadel, San Jose, CA (US); Amin Haghmoradi, San Jose, CA (US)

(21) Appl. No.: 19/424,426

(22) Filed: Dec. 18, 2025

Related U.S. Application Data
(60) Provisional application No. 63/740,393, filed on Dec. 31, 2024.

(51) Int. Cl. C08J 11/24; C08J 11/08; D01G 11/00; D06P 1/92; D06P 3/82; D06P 5/13

(52) U.S. Cl. CPC C08J 11/24; C08J 11/08; D01G 11/00; D06P 3/8223; D06P 5/13; C08J 2301/02; C08J 2367/02; D06P 1/928; D10B 2201/02

(57) ABSTRACT

Chemical processing techniques for separating components of mixed textile feedstocks for recycling are described. In an embodiment, a method can comprise contacting a mixed textile feedstock comprising a polyester material, a cellulosic material, a disperse colorant, and elastomeric polymers with a solution comprising a cyclic ketone solvent at a first temperature to extract at least some of the disperse colorant and at least some of the elastomeric polymers, resulting in an intermediate textile feedstock excluding the at least some of the disperse colorant and the at least some of the elastomeric polymers; contacting the intermediate textile feedstock with the solution at a second temperature greater than the first temperature to extract at least some of the polyester material in the solution; and extracting the at least some of the polyester material from the solution, resulting in extracted polyester material. The method further results in isolated cellulosic material.

### TECHNICAL FIELD

The subject disclosure relates generally to chemical processing techniques for separating components of mixed textile feedstock for recycling.

### BACKGROUND

Polyester is amongst the most commonly used global fiber market, ubiquitous in the fashion industry. The global fiber production reached 116 million tons in 2022, with synthetic fibers accounting for 65% of this total. Polyester fiber production alone reached 63.3 million tons, representing 54% of global fiber production, while cotton and nylon represent 22% and 5%. With continued population growth, global fiber production is expected to keep increasing at an annual growth rate of 1.2%. However, this significant production volume also leads to the generation of a large amount of textile waste. Less than 1% of textile waste is recycled fiber-to-fiber, with approximately 73% landfilled or incinerated, 14% lost during production and collection, and 12% downcycled into lower-value applications.

Polyethylene terephthalate (PET) accounts for roughly 10.2% of global plastic production, and two thirds of all polyesters. It is primarily used to produce bottles and textiles or fabrics. However, owing to the mixed materials found in most textiles, such as colorants, elastomeric materials, spandex, cotton and other additives, recovering clean PET and other clean polyesters from such mixed fabric feedstocks for recycling is challenging using current recycling technology.

In view of the foregoing, there remains a need in the art for efficient methods of processing mixed fabric feedstocks in association with usage of such fabrics for generating recycled products.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later.

According to an embodiment, a method for separating components of a mixed textile feedstock is provided, wherein the mixed textile feedstock comprises a disperse colorant, a polyester material, elastomeric polymers and a cellulosic material. The method comprises extracting at least some of the disperse colorant and at least some of the elastomeric polymers from the mixed textile feedstock using a first extraction process, resulting in an intermediate textile feedstock that excludes the at least some of the disperse colorant and the at least some of the elastomeric polymers and retains the polyester material and the cellulosic material, wherein the first extraction process comprises contacting the mixed textile feedstock to a solution comprising a solvent in association with heating the solution to a first temperature, wherein the solvent comprises a ketone and/or an ether. The method further comprises extracting at least some of the polyester material from the intermediate textile feedstock using a second extraction process, resulting in a purified cellulosic material that excludes the at least some of the polyester material, the at least some of the disperse colorant and the at least some of the elastomeric polymers, wherein the second extraction process comprises contacting the intermediate textile feedstock to the solution in association with heating the solution to a second temperature higher than the first temperature.

In another embodiment, another method for separating components of a mixed textile feedstock is provided, wherein the mixed textile feedstock comprises a disperse colorant, a polyester material, elastomeric polymers and a cellulosic material. The method comprises, extracting at least some of the disperse colorant from the mixed textile feedstock using a first extraction process resulting in a first intermediate textile feedstock that excludes the at least some of the disperse colorant and retains the elastomeric polymers, the polyester material and the cellulosic material, wherein the first extraction process comprises contacting the mixed textile feedstock to a solution comprising a solvent in association with heating the solution to a first temperature, and wherein the solvent comprises a ketone and/or an ether. The method further comprises extracting at least some of the elastomeric polymers from the first intermediate textile using a second extraction process, resulting in a second intermediate textile feedstock that excludes the at least some of the elastomeric polymers and retains the polyester material and the cellulosic material, wherein the second extraction process comprises contacting the first intermediate textile feedstock to the solution in association with heating the solution to a second temperature higher than the first temperature. The method further comprises extracting at least some of the polyester material from the second intermediate textile feedstock using a third extraction process, resulting in a purified cellulosic material that excludes the at least some of the polyester material, the at least some of the disperse colorant and the at least some of the elastomeric polymers, wherein the second extraction process comprises contacting the second intermediate textile feedstock to the solution in association with heating the solution to a third temperature higher than the second temperature.

In one or more additional embodiments, another method for separating components of a mixed textile feedstock is provided, wherein the mixed textile feedstock comprises a polyester material, elastomeric polymers and a cellulosic material. The method comprises extracting at least some of the elastomeric polymers from the mixed textile feedstock using a first extraction process, resulting in an intermediate textile feedstock that excludes the at least some of the elastomeric polymers and retains the polyester material and the cellulosic material, wherein the first extraction process comprises contacting the mixed textile feedstock to a solution comprising a solvent in association with heating the solution to a first temperature, wherein the solvent comprises a ketone and/or an ether. The method further comprises extracting at least some of the polyester material from the intermediate textile feedstock using a second extraction process, wherein the second extraction process comprises contacting the intermediate textile feedstock to the solution in association with heating the solution to a second temperature greater than the first temperature.

### BRIEF DESCRIPTION OF THE DRAWINGS

The Applicant hereby petitions the Director to accept color drawings and photographs in this application. The color drawings and photographs are necessary as the subject matter cannot be adequately understood in black and white.

One or more embodiments are described below in the Detailed Description section with reference to the following drawings:

FIG. 1 illustrates a flow diagram of an example, non-limiting method for separating components of mixed textile feedstock for recycling., in accordance with one or more embodiments described herein;

FIG. 2 presents chemical structures of several example colorants capable of being removed from mixed textile feedstock, in accordance with one or more embodiments described herein;

FIGS. 3A and 3B illustrate a flow diagram of another example, non-limiting method for separating components of mixed textile feedstock for recycling, in accordance with one or more embodiments described herein;

FIG. 4 presents an example, non-limiting batch extraction system for separating components of mixed textile feedstock for recycling, in accordance with one or more embodiments described herein;

FIG. 5 presents an example, non-limiting system for recovering polyester from a high-temperature polyester-solvent solution using an optional hot-filtration and controlled-precipitation operation;

FIG. 6 illustrates an example implementation of a chemical recycling process for transforming a purified polyester material into a recycled polyester material, in accordance with one or more embodiments described herein.

FIG. 7 presents fabric sample before and after polyester extraction, in accordance with an experimental implementation of an extraction process disclosed herein;

FIG. 8 present microscopic images of fabric sample before and after polyester extraction, in accordance with an experimental implementation of an extraction process disclosed herein;

FIGS. 9A and 9B presents analysis results on a glycolysis product produced from extracted polyester in accordance with two experimental implementations of an extraction process disclosed herein;

FIG. 10 illustrates an example continuous flow reaction system in accordance with one or more embodiments described herein;

FIG. 11 illustrates another example continuous flow reaction system in accordance with one or more embodiments described herein;

FIG. 12 illustrates another example continuous flow reaction system in accordance with one or more embodiments described herein;

FIG. 13 illustrates another example continuous flow reaction system in accordance with one or more embodiments described herein;

FIG. 14 illustrates another example continuous flow reaction system as applied to the method of FIG. 1, in accordance with one or more embodiments described herein;

FIGS. 15A and 15B illustrates another example continuous flow reaction system as applied to the method of FIG. 3, in accordance with one or more embodiments described herein.

FIGS. 16A and 16B presents a table illustrating results of Experiments 1-10;

FIGS. 17A-17C present images illustrating results of Experiments 1-10;

FIG. 18 presents microscopic images of fabric before and after spandex removal, in accordance with Experiments 9 and 10.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

The present innovation overcomes the need in the art with efficient extraction processes that isolate clean polyester material from mixed textile feedstocks containing polyester, colorant, elastomers, cellulosic material (e.g., cotton and others) and other additives. The clean polyester material may further be efficiently transformed into high-quality recycled materials using existing chemical and/or mechanical recycling processes without requiring post-processing steps. The disclosed extraction processes further provide for extracting individual components of mixed fabric feedstocks, including colorant, elastomers, and dyed cellulosic material, which may also be reused and/or recycled.

One non-limiting example of a chemical recycling process that may use the purified polyester material of the claimed methods is the volatile catalyst (VolCat) method described in U.S. Pat. No. 9,255,194 B2 to Allen et al. and U.S. Pat. No. 9,914,816 B2 to Allen et al. The VolCat process depolymerizes PET rapidly via glycolysis using an organocatalyst such as ethylene glycol into the molecule Bis(2-hydroxyethyl)terephthalate (BHET), which can be repolymerized into polyester. This process has drawn industrial interest due to its potential to valorize low-cost waste streams and divert a sizeable portion of waste from landfills. The technology is well suited to process bottle flake inputs by extracting the PET component from other plastics and additives during the solution process. The VolCat process is less resilient against contamination from components found in textiles, such as colorants, elastomers, cellulosic material, and dyed cellulosic material.

More particularly, the depolymerization of polyester by glycolysis with ethylene glycol has been found to proceed rapidly in the presence of triethylamine catalyst. For bottle flakes, the additives present are typically insoluble and filtered post-glycolysis. Due to the ease of sorting bottle flakes much of this feedstock is fit for mechanical recycling, especially as the capabilities of materials recycling/recovery facilities (MRFs) have increased. Currently, MRFs do not have the capacity to sort clothing for thermomechanical recycling, leaving waste PET clothing outside the capabilities of the current recyclables market. However, these fabrics can be processed by chemical recycling (glycolysis). The challenge is most polyester fabrics contain other fibers including cotton and elastomers, along with dyes that are known to dissolve during glycolysis and contaminate the BHET product with elastane residues and color. Accumulation of dye and elastane in these processes deteriorates the BHET properties below what repolymerization facilities are willing to accept. Therefore, a pretreatment process is necessary to remove these contaminants before glycolysis.

Current methods for colorant removal on polyester-cotton (polycotton) fabrics typically use alkaline bleaching processes that can damage the polyester and deposit contaminants into the glycolysis process that will co-precipitate with BHET. Additionally, these methods do not remove elastomeric polymers such as polyurethane, polyether, polyurea, and ethylene vinyl acetate (EVA), polyvinyl chloride (PVC) and others. Although the VolCat process can extract PET from a polycotton fabric while leaving the cotton undissolved, extensive study has shown the cotton dyes will partition into the reaction product and discolor the BHET below acceptable color specification.

The disclosed methods thus provide the necessary pre-treatment step to sort the PET from the other textile components prior to depolymerization via glycolysis, thus greatly extending the application of the VolCat process and other textile polymer recycling process to textiles and fabrics currently being landfilled or incinerated.

The disclosed extraction processes can efficiently isolate individual components of mixed fabric feedstocks (e.g., polyester, colorant, elastomers, and cellulosic material (e.g., cotton and others) using a single solvent by merely modifying the temperature. The solvent realized to accomplish this extraction comprises a ketone solvent and/or an ether solvent. In various embodiments, the ketone solvent comprises a cyclic ketone such as cyclopentanone, cyclohexanone, or a combination thereof. In other embodiments, the solvent may include an ether solvent such as diphenyl ether. In comparison to other polymer dissolution-based processes, this process uniquely passes through a low viscosity soluble state followed by a simple precipitation and filtration step after cooling to isolate the polyester component away from uncontaminated cellulosic materials.

In an embodiment, a two-step extraction process is provided that first extracts both disperse colorant and elastomeric polymers included in dyed mixed textile feedstocks, containing polyester and cotton (or another type of cellulosic material), resulting in an intermediate fabric feedstock comprising clean polyester and dyed cotton (or another type of cellulosic material). The first step of the two-step extraction process involves contacting a solution comprising the solvent with the mixed fabric feedstock in association with heating the solution to a first temperature. The second step of the two-step extraction process involves contacting the intermediate fabric feedstock to the solution in association with heating the solution to a second temperature higher than the first temperature, which results in dissolving the clean polyester away from the dyed cotton into a mixture comprising the solvent and the clean polyester, which is then recovered via precipitation and cooling. In various implementations, the first temperature is between about 120° Celcious (C) and about 150° C. and the second temperature is greater than or equal to 170° C. The recovered, purified polyester may then be used to form new polyester products as is, and/or efficiently transformed into a high-quality recycled products using existing chemical and/or mechanical recycling processes. For example, in some embodiments, the purified polyester (e.g., PET) may be subjected to a chemical recycling process such as depolymerization by glycolysis into BHET. Then, the produced BHET is optionally repolymerized into PET. In addition, the dyed cotton resulting is devoid of elastane and other contaminants, which may also be recycled and/or reused as is.

In another embodiment, a three-step extraction process is provided that provides for selectively extracting disperse colorant from the polyester fibers of the mixed textile feedstock and separately extracting the elastane material prior to extracting the purified polyester material from the dyed cotton. With these embodiments, the isolated colorant and isolated elastane may also be reused for other applications. In an example embodiment, the first step of the three-step process first extracts disperse colorant from the polyester fibers of the mixed textile feedstock by contacting the mixed textile feedstock to a solution comprising the solvent in association with heating the solution to a first temperature, resulting in a first intermediate fabric feedstock and isolated disperse colorant. The second step of the three-step process then extracts elastane from the first intermediate textile feedstock by contacting the first intermediate fabric feedstock to the solution in association with heating the solution to a second temperature higher than the first temperature, resulting in a second intermediate fabric feedstock and isolated elastane material, wherein the second intermediate textile feedstock comprises clean polyester material and dyed cotton material. The third three-step process then extracts the clean polyester material from the second intermediate fabric feedstock by contacting the second intermediate fabric feedstock to the solution in association with heating the solution to a third temperature higher than the second temperature, which results in dissolving the clean polyester away from the dyed cotton into a mixture comprising the solvent and the clean polyester, which is then recovered via precipitation and cooling. In various implementations, the first temperature is between about 50° C. and about 100° C., the second temperature is between about 120° C. and about 150° C. and the third temperature is greater than or equal to 170° C. The recovered, purified polyester may then be used to form new polyester products as is, and/or efficiently transformed into a high-quality recycled products using existing chemical and/or mechanical recycling processes. For example, in some embodiments, the purified polyester (e.g., PET) may be subjected to a chemical recycling process such as depolymerization by glycolysis into BHET. Then, the produced BHET is optionally repolymerized into PET. In addition, the dyed cotton resulting is devoid of elastane and other contaminants, which may also be recycled and/or reused as is.

In various implementations, some or all of the extraction processes disclosed herein further recover and reuse the solvent for multiple extractions over time using a continuous flow extraction system. In accordance with the continuous flow extraction system, the respective components of the mixed textile feedstock and the intermediate textile feedstocks are extracted by placing the fabric feedstock within a chamber and exposing the material to a continuously condensed hot solvent that passes through the material as positioned within the chamber and extracts the respective components from the material. The solvent that has passed through the material may be subsequently recollected, reevaporated, recondensed, and passed back through the material within the chamber to extract additional components (e.g., additional colorant and/or elastane material) form the fabric over a duration of time until a desired amount of the respective components have been removed.

Additionally, the continuous flow extraction system can include a mechanical conveyance mechanism that provides for continuously feeding additional contaminated fabric feedstock (e.g., comprising colorant, elastane and/or dyed cotton) into the extraction chamber and removing the purified material from the chamber. With these embodiments, the solution comprising the cyclic ketone solvent is heated and directed into the chamber in a direction countercurrent to the feed flow of the contaminated fabric feedstock. In some embodiments, separate subsystems (including separate chambers) can be used for respective steps of the two-step and three-step extraction processes. With these embodiments, the mechanical conveyance mechanism can also provide for conveying intermediate fabric material from one chamber to the next. Additionally, in some embodiments, the mechanical conveyance system can also convey the purified polyester material directly into a chemical and/or mechanical recycling system where the purified polyester material is transformed into a recycled polyester material.

The term “mixed textile material,” “blended textile material”, and variations thereof, is used herein to refer to any textile material made from two or more different types of fibers or textile materials, which may be either blended at the fiber level or combined as layers or components in a finished fabric. In accordance with the disclosed techniques, at least one of the two or more different types of textile materials includes or otherwise incorporates elastomeric polymers. The other type or types of fibers or textile materials included in the mixed textile material can vary and may include (but are not limited to), a polyester material, a nylon material, an acrylic material, a natural fiber material (e.g., cotton, wool, silk, flax and other cellulosic materials), or man-made cellulosic fibers (MMCF's) such as linen and, viscose, and others. The terms “textile” and “fabric”, “cloth” and the like are used interchangeably unless context warrants particular distinction amongst the terms.

For purposes of the present disclosure, “colorant” refers to any chemical substance, compound, mixture, pigment, dye, or coloration agent that imparts, modifies, enhances, or alters visible color, shade, hue, tint, tone, depth, or appearance of a textile material, including both coloration that is chemically bound to a fiber and coloration that is physically or mechanically adhered, applied, coated, or deposited on a fiber surface, unless context warrants particular distinction amongst the terms. The term colorant is intended to encompass all natural and synthetic dyes, pigments, inks, stains, tinting agents, optical brighteners and other chromophoric materials, whether water-soluble, solvent-soluble, dispersed, particulate, polymer-bound, or microencapsulated. In this regard, the terms “colorant,” “pigment,” “dye” and variations thereof, are used herein interchangeably, unless context warrants particular distinction amongst the terms.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

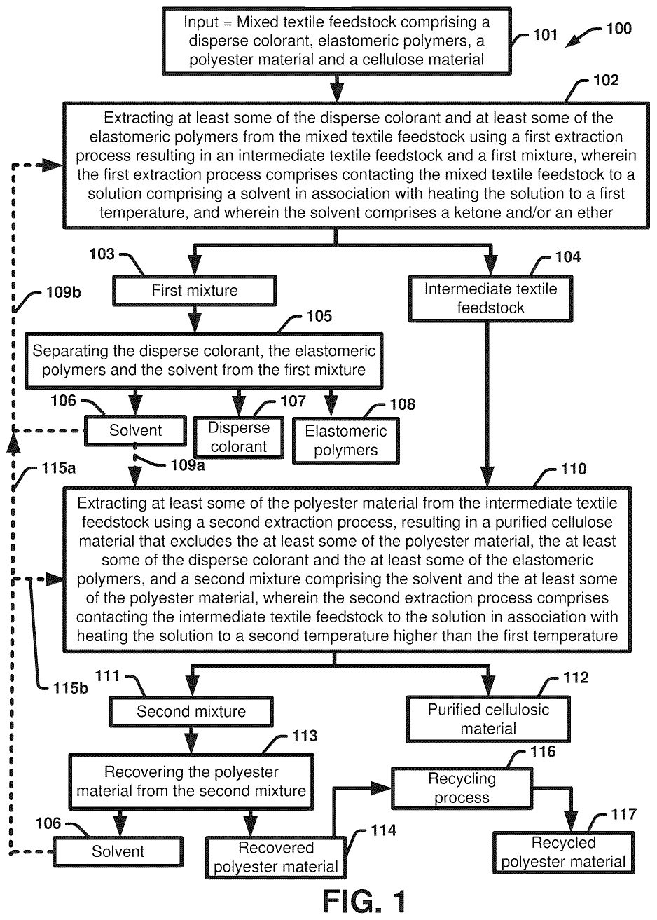

FIG. 1 illustrates a flow diagram of an example, non-limiting method 100 for separating components of mixed textile feedstock for recycling, in accordance with one or more embodiments described herein. The input for method 100 includes mixed textile feedstock 101, wherein the mixed textile feedstock 101 includes (but is not limited to) a disperse colorant, elastomeric polymers, a polyester material and a cellulosic material.

The cellulosic material of the mixed textile feedstock 101 can comprise any natural, regenerated, or man-made cellulosic fiber that contains cellulose as its principal structural component. In various embodiments, the cellulosic material includes natural cellulose fibers such as cotton, flax, hemp, jute, and/or other plant-derived fibers. In additional embodiments, the cellulosic material includes man-made cellulosic fibers (MMCFs), such as rayon, viscose, lyocell, modal, cupro, or other regenerated cellulose fibers and cellulose-based derivatives. As used herein, “cellulosic material” excludes non-cellulosic natural fibers such as wool or silk, but encompasses any hydroxyl-functional fiber containing cellulose capable of forming hydrogen bonds or covalent interactions with fiber-reactive dye classes. In certain embodiments, the cellulosic material comprises cotton, which is a common component of mixed poly-cotton textile feedstocks.

The polyester material of mixed textile feedstock 101 can include any aromatic, aliphatic, or aliphatic-aromatic polyester used in textile fibers, films, yarns, or blended fabrics. In various embodiments, the polyester material includes, but is not limited to, polyethylene terephthalate (PET), polyethylene naphthalate (PEN), polybutylene terephthalate (PBT), polytrimethylene terephthalate (PTT), polyethylene furanoate (PEF), copolyesters such as PET-G (glycol-modified polyethylene terephthalate), isophthalate-modified polyesters, cyclohexanedimethanol-modified polyesters, and other polyester chemistries derived from terephthalic, isophthalic, naphthalene dicarboxylic, or furan dicarboxylic acids. In some embodiments, the polyester material may additionally include bio-based polyesters, recycled polyesters, or blends of polyester with other polymers, provided that the polyester component retains the ester-linked backbone characteristic of polyester fibers used in textile applications. In certain embodiments, the polyester material comprises PET, which is widely used in poly-cotton textiles.

These polyester materials contain ester linkages and hydrophobic aromatic domains that enable them to soften, swell, or dissolve when contacted with the heated solvents described herein, thereby facilitating selective removal of disperse colorants and elastomeric polymers from the polyester phase in the mixed textile feedstock 101.

The elastomeric polymers of the mixed textile feedstock 101 can include any synthetic or semi-synthetic polymer that imparts elasticity, stretch, recovery, or deformability to the textile. In various embodiments, the elastomeric polymers include, but are not limited to, elastane (spandex), polyurethane (PU) elastomers, thermoplastic polyurethane (TPU), polyether-urethane and polyester-urethane block copolymers, styrenic block copolymers (e.g., SBS, SEBS, SIS), ethylene-vinyl acetate (EVA) copolymers, thermoplastic elastomers (TPEs), thermoplastic polyolefin elastomers (TPOs), thermoplastic polyamide elastomers (PEBA/TPA elastomers), silicone-based elastomers, rubber-modified polyolefins, and combinations thereof.

These elastomeric polymers may be present as discrete fibers (e.g., spandex filaments), bicomponent fibers, sheath-core structures, films, coatings, stretch-yarns, or blended components within the polyester-rich portion of the mixed textile feedstock 101. In certain embodiments, the elastomeric materials are incorporated into the polyester yarns or knitted structures to impart stretch and recovery properties.

Because elastomeric polymers typically possess urethane linkages, soft-segment polyether or polyester domains, and phase-separated morphologies, they can swell, soften, or dissolve under the solvent extraction conditions described herein. Accordingly, in some embodiments, the disclosed solvent extraction processes remove all or a portion of the elastomeric polymers from the mixed textile feedstock 101, facilitating the generation of a purified polyester and purified cellulose from the mixed textile feedstock 101.

In this regard, mixed textile feedstock 101 corresponds to blended (and colored) fabric material comprising (at least) elastomeric polymers, a polyester material and a cellulosic material (e.g., cotton or another cellulosic material). The relative amounts of elastomeric polymers, polyester material and cellulosic material included in the mixed textile feedstock 101 can vary. For example, in some embodiments, the amount of elastomeric polymers is between about 1% to about 90% by mass, the amount of polyester material is between about 1% to about 90% by mass, and the amount of cellulosic material is between about 1% to about 90% by mass. In another embodiment, the amount of elastomeric polymers is between about 1% to about 80% by mass, the amount of polyester material is between about 1% to about 80% by mass, and the amount of cellulosic material is between about 1% to about 80% by mass. In another embodiment, the amount of elastomeric polymers is between about 1% to about 70% by mass, the amount of polyester material is between about 1% to about 70% by mass, and the amount of cellulosic material is between about 1% to about 70% by mass. In another embodiment, the amount of elastomeric polymers is between about 1% to about 60% by mass, the amount of polyester material is between about 1% to about 60% by mass, and the amount of cellulosic material is between about 1% to about 60% by mass. In another embodiment, the amount of elastomeric polymers is between about 1% to about 50% by mass, the amount of polyester material is between about 1% to about 50% by mass, and the amount of cellulosic material is between about 1% to about 50% by mass. In another embodiment, the amount of elastomeric polymers is between about 1% to about 40% by mass, the amount of polyester material is between about 1% to about 40% by mass, and the amount of cellulosic material is between about 1% to about 40% by mass.

In some embodiments, the elastomeric polymer content of the mixed textile feedstock 101 is between about 1.0% by mass and about 5.0 % by mass, such as in lightweight stretch apparel or athleisure fabrics. In other embodiments, the elastomeric polymer content is between about 5.0% by mass and about 20% by mass as may be present in high-stretch activewear, shapewear, or performance textiles. The disclosed extraction process selectively removes all (100%), or substantially all (between 95% and about 100%) of the elastomeric polymers from the mixed textile feedstock 101 across these loading ranges and higher ranges.

In some embodiments, the polyester content of the mixed textile feedstock 101 is between about 50% by mass and about 95% by mass, such as in blended fabrics containing cotton and low-to-moderate amounts of elastomeric polymers and cotton (or another cellulosic material). In other embodiments, the polyester content may be between about 10% by mass and about 50% by mass. The disclosed extraction process selectively removes all (100%), or substantially all (between 95% and about 100%), of the polyester content from the mixed textile feedstock 101 across these loading ranges.

In some embodiments, as opposed to being in the form of a textile, fabric, cloth or the like, the input of method 100 may be in the form of a granulate, bottle flake, a sheet, a dense granulate, pellet, or a molded article. Bottle flake refers to small flakes of plastic obtained from recycled plastic bottles, typically made of PET. These flakes are produced by shredding used plastic bottles into small pieces after cleaning and removing labels and caps. With these embodiments, the composition of the input material can correspond to the compositions noted above as described with respect to the mixed textile feedstock 101.

The disperse colorant of mixed textile feedstock 101 may comprise one or more disperse dyes, pigment particles, or other non-ionic, hydrophobic colorant species that impart color to polyester fibers. As used herein, the term “disperse colorant” refers broadly to any colorant that is substantive to polyester and becomes associated with the polyester phase through physical dispersion, molecular dissolution, adsorption, or entrapment within the amorphous regions of the polyester polymer. Disperse colorants are typically non-ionic, sparingly water-soluble organic molecules or pigment particles having limited affinity toward hydrophilic fibers such as cotton or other cellulosic materials. In this regard, the term disperse colorant includes, but is not limited to, disperse dyes, pigments and optical brighteners.

In some embodiments, the disperse colorant includes or corresponds to a disperse dye or pigment whose chromophore is based on a wide variety of chemical functionality, including but not limited to azo dyes, anthraquinone dyes, benzodifuranone dyes, phthalocyanine dyes, violanthrone dyes, coumarin dyes, methine dyes, and other hydrophobic chromophoric structures. Certain pigment systems may also be present, including inorganic particulates such as titanium dioxide, carbon black, or colored metal-oxide pigments dispersed within a polymeric binder or within the polyester fiber itself.

In many commercial polyester dyeing processes, disperse colorants are not covalently bonded to the polyester. Instead, the colorant molecules or pigment particles are physically deposited, diffused, or entrapped within the polyester fiber matrix, enabling their subsequent removal when the polyester is solubilized or swollen by the disclosed solvents under the conditions described herein.

The amount of disperse colorant included in the mixed textile feedstock 101 can vary according to the textile construction, dye class, and depth of shade. For example, in some embodiments, the amount of disperse colorant included in the mixed textile feedstock 101 is between about 1% by mass to about 20% by mass. In another embodiment, the amount of disperse colorant included in the mixed textile feedstock is between about 0.5% by mass to about 10% by mass. The disclosed extraction process selectively removes all (100%), or substantially all (between 95% and about 100%), of the disperse colorant content from the mixed textile feedstock 101 across these loading ranges.

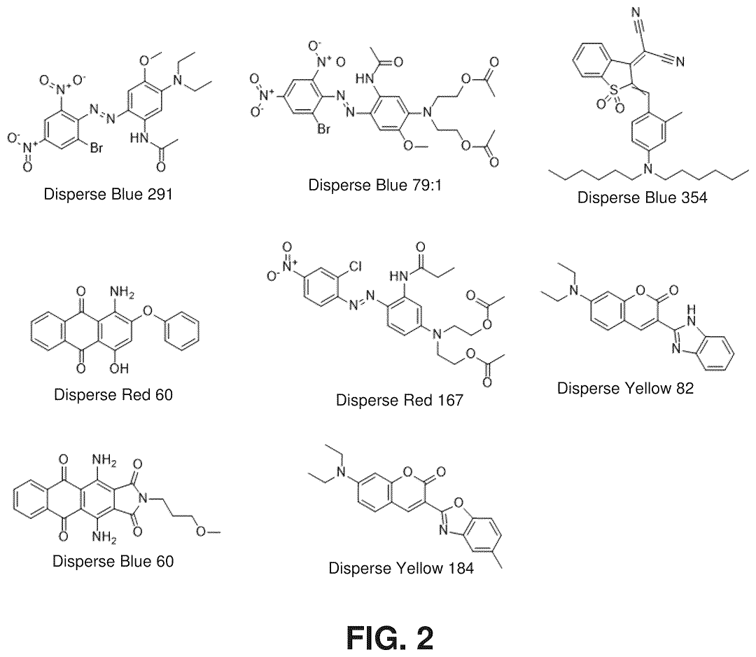

FIG. 2 presents chemical structures of several example disperse colorants capable of being removed from mixed textile feedstock 101, in accordance with one or more embodiments described herein. The disperse colorants illustrated in FIG. 2 are disperse dyes which are widely used to color polyester. In various embodiments, the mixed textile feedstock 101 processed in accordance with method 100 and other methods described, has been dyed with one or more disperse dyes, such as those presented in FIG. 2. In accordance with these embodiments, method 100 and additional methods described herein can be adapted (e.g., as a function of temperature of the heated solution, concentration of the solvent, duration of contacting, number of repeated contacting steps, and other variables described herein, to remove all or substantially all of the disperse colorant from the polyester material of the mixed textile feedstock 101.

Dyeing polyester is generally more complex than dyeing natural fibers due to the highly hydrophobic nature and low dye affinity of polyester. To achieve deep and durable coloration, disperse dyes are typically applied under high-temperature dyeing conditions, such as at temperatures between about 110° C. and 130° C. under pressurized aqueous dyebath conditions. At these temperatures, the amorphous regions of polyester become sufficiently molecularly mobile and swellable, allowing disperse dye molecules to diffuse into and become physically encapsulated within the polyester fiber.

In various embodiments, removal of disperse dyes and other types of disperse colorants (e.g., optical brighteners, disperse pigments, etc.) from the polyester component can be achieved by contacting the colored polyester material with a heated solution comprising a solvent, wherein the solvent comprises an alcohol, an ether, an ester, and/or a ketone. In various embodiments, the solvent may comprise a cyclic ketone, including (but not limited to) cyclobutanone, cyclopentanone, cyclohexanone, or a combination thereof. Additionally, or alternatively, the solvent may comprise diphenyl ether. In other embodiments, the solvent may comprise 1,4-dioxane, 1,3-dioxolane, tetrahydrofuran, 2-methyl tetrahydrofuran, dimethyl carbonate, diethyl carbonate, ethyl lactate, ethyl acetate, or a combination thereof. The heated solution is maintained at a temperature below the melting temperature of the polyester yet high enough to soften, swell, or partially solubilize the polyester phase. Under these conditions, disperse colorants partition preferentially into the solvent phase together with the solubilized or swollen polyester fraction, thereby enabling selective removal of disperse colorants from the polyester component of the mixed textile feedstock 101.

In this regard, in some embodiments, the mixed textile feedstock 101 may also include one or more fiber-reactive colorants. As used herein, the term “fiber-reactive colorant” refers broadly to any dye, pigment, colorant precursor, or chromophoric species that exhibits affinity toward, or is chemically bonded and/or or physically fixated (e.g., immobilized) on or within cellulosic fibers such as cotton, rayon, lyocell, viscose, modal, flax, hemp, and other hydroxyl-functional natural or regenerated cellulosic materials. Fiber-reactive colorants include colorants that form covalent bonds with cellulose, undergo in-fiber oxidation or reduction- oxidation cycles yielding insoluble pigments within the fiber interior, become physically entrapped within the cellulose microfibril structure and/or are electrostatically or hydrogen-bond bound to cellulose surfaces.

Fiber-reactive colorants are distinct from disperse colorants in that disperse colorants lack chemical affinity for cellulose and do not form covalent or strong non-covalent interactions with cellulose. By contrast, fiber-reactive colorants are intentionally designed to remain associated with cellulose under aqueous, thermal, and laundering conditions, and therefore commonly persist on cotton even when disperse dyes are removed from polyester during solvent extraction.

In embodiments in which the mixed textile feedstock 101 includes one or more fiber-reactive colorants, the fiber-reactive colorants may include, but are not limited to, reactive dyes, vat dyes, sulfur dyes, direct dyes, and/or pigment-based colorants deposited via printing or coating processes.

Reactive dyes include dichlorotriazine, monochlorotriazine, vinyl sulfone, triazine-vinyl sulfone, heterobifunctional reactive dyes, and other electrophilic dye systems. Reactive dyes contain reactive functional groups that undergo nucleophilic substitution or Michael-type addition with hydroxyl groups of cellulose during dyeing, thereby forming a covalent ether linkage to the cellulose backbone. Because of this covalent fixation, reactive dyes exhibit minimal solubility in non-aqueous organic solvents and are not readily removed by the cyclic-ketone solvent under the extraction conditions used for polyester purification. However, in some embodiments, depending on the degree of fixation or the presence of hydrolyzed dye species, the solvents disclosed herein may remove trace or unfixed portions of reactive dyes.

Vat dyes include indigo, anthraquinone-based vat dyes, and related polycyclic chromophores. Vat dyes are applied in a reduced, soluble leuco form, which then penetrates the cellulose fiber. Upon in-fiber oxidation, the dye is converted to an insoluble pigment embedded within the internal fiber matrix. This pigment is held in place via π-π stacking, hydrogen bonding, and physical entrapment rather than covalent bonding. Vat dyes are largely insoluble in the cyclic ketone solvents disclosed herein and remain on the cellulose under typical extraction conditions. However, in some embodiments, the solvent may remove superficial, loosely bound, or partially reduced vat dye residues.

Sulfur dyes, which are polymeric, have sulfur-rich chromophores applied in a reduced form and oxidized in situ to yield a high-molecular-weight, insoluble pigment within the cellulosic fibers. The oxidized sulfur dye species are held within the cellulose structure primarily through physical entrapment and non-covalent interactions. These species are generally insoluble in the cyclic ketone solvent disclosed herein and remain attached during polyester colorant extraction. Nevertheless, in certain embodiments, minor amounts of sulfur dye degradation products or unfixed sulfur dye residues may be solubilized or displaced by the solvent.

Direct dyes are typically large, planar, anionic dye molecules exhibiting strong substantivity toward cellulose. Direct dyes bind to cellulose primarily through hydrogen bonding, van der Waals interactions, and linear stacking interactions along cellulose chains. Although direct dyes exhibit relatively good wash fastness, they lack covalent attachment. Accordingly, in some embodiments, depending on solvent polarity, temperature, and extraction parameters, the cyclic ketone solvents disclosed herein may remove a portion of direct dyes, particularly those weakly bound or residing on the fiber surface.

In some embodiments, the cellulosic material may further contain pigment-based colorants deposited via printing or coating processes. These systems typically include organic or inorganic pigments (e.g., metal-oxide pigments, titanium dioxide, carbon black) dispersed within a polymeric binder, such as acrylic, polyurethane, or styrene-acrylate copolymers, that adheres to the cellulose surface. Under certain solvent extraction conditions, the cyclic ketone solvents disclosed herein may soften, swell, or partially dissolve the binder matrix, enabling at least partial removal of pigment-binder colorants from the cellulose surface.

In some embodiments, the mixed textile feedstock 101 may further include additional textile/fiber materials beyond the polyester, elastomeric, and cellulosic components described above. These additional textile materials may include, but are not limited to, natural protein-based fibers such as wool, silk, cashmere, mohair, alpaca, or camel hair; nylon and other polyamide fibers (e.g., PA6, PA6,6, PA11, PA12); acrylic fibers (e.g., polyacrylonitrile and acrylonitrile copolymers); polyolefin fibers (e.g., polypropylene, polyethylene, high-density polyethylene, linear low-density polyethylene); acetate and triacetate fibers; aramid fibers (e.g., Kevlar®, Nomex®); polylactic acid (PLA) fibers; polyurethane-coated or laminated fibers; polyvinyl alcohol (PVA) fibers; polyvinyl chloride (PVC)-based fibers; polyetherimide fibers; polyester-polyamide bicomponent fibers; glass fibers; carbon fibers; metallized fibers; ceramic fibers; and combinations thereof. In certain embodiments, the presence of these additional fiber materials does not interfere with the selective dissolution and removal of disperse colorants and elastomeric polymers from the polyester phase. Their behavior under extraction conditions may facilitate downstream separation, mechanical handling, or purification of one or more recovered components.

In some embodiments, the mixed textile feedstock 101 may also include one or more other additive components such as but not limited to: a lubricant agent, a perfluoroalkyl substance, a polyfluoroalkyl substance, a scouring agent, an anti-foam agent, a leveling agent, an antistatic compound, a water repellent, an emulsifier, a surfactant, a flame retardant, a wicking agent, dirt and grime, and combinations thereof. Under the solvent extraction conditions disclosed herein, these additives are also removed by the solvents disclosed herein, in association with the removal of the disperse colorant and elastomeric components. In certain embodiments, partial or complete removal of these additives may further enhance the purity of the recovered polyester, cellulose, or elastomeric fractions.

With reference now to method 100, at 102 method 100 comprises extracting at least some of the disperse colorant and at least some of the elastomeric polymers from the mixed textile feedstock 101 using a first extraction process resulting in an intermediate textile feedstock 104 and a first mixture 103, wherein the first extraction process comprises contacting the mixed textile feedstock 101 to a solution comprising a solvent in association with heating the solution to a first temperature, and wherein the solvent comprises a ketone and/or an ether.

To this end, the first mixture 103 comprises the solvent, the at least some of the disperse colorant, and the at least some of the elastomeric polymers. The intermediate textile feedstock 104 excludes the at least some of the disperse colorant and the at least some of the elastomeric polymers yet retains the polyester material and the cellulose material. In some embodiments in which the mixed textile feedstock 101 includes one or more other additive components (e.g., a lubricant agent, a perfluoroalkyl substance, a polyfluoroalkyl substance, a scouring agent, an anti-foam agent, a leveling agent, an antistatic compound, a water repellent, an emulsifier, a surfactant, a flame retardant, a wicking agent, dirt and grime, and combinations thereof), at least some of these additive components are also removed from the mixed textile feedstock as a result of the first extraction process.

In various embodiments, the solvent is a cyclic ketone that comprises 5 to 10 carbon atoms. In some embodiments, the cyclic ketone comprises cyclopentanone, cyclohexanone or a combination thereof. In other embodiments, the solvent may comprise an ether, such as diphenyl ether. Still in other embodiments, the solvent can include cyclopentanone, cyclohexanone, diphenyl ether or a combination thereof.

The conditions of the first extraction process performed at 102 can vary depending on the amount and type of disperse colorant included in the mixed textile feedstock 101, the desired amount of disperse colorant to be removed, the amount and type of elastomeric polymers included in the mixed textile feedstock 101 and the desired amount of elastomeric polymers to be removed, the amount and type of the polyester material included in the mixed textile feedstock 101, the duration of contacting, the first temperature to which the solution is heated, and the concentration of the solvent in the solution (among other factors). These conditions can be tailored in accordance with the specifications described herein in order to remove all (100%) or substantially all (between 95% and 100%) of the disperse colorant and all (100%) or substantially all (between 95% and 100%) of the elastomeric polymers included in the mixed textile feedstock 101, regardless of the amount of the type and amount of disperse colorant and the type and amount of elastomeric polymers included in the mixed textile feedstock 101, yet retain all (100%) or substantially all (between 95% and 100%) of the polyester material of the mixed textile feedstock 101 within the intermediate textile feedstock 104, regardless of the amount and type of the polyester material.

To this end, under the conditions specified herein for the first reaction process of method 100, the intermediate textile feedstock 104 resulting from the first extraction process can comprise less than 2% by mass of disperse colorant, less than 1% by mass of disperse colorant, less than 0.5% by mass of disperse colorant, or less than 0.2% by mass of disperse colorant. Likewise, under the conditions specified herein for the first reaction process of method 100, the intermediate textile feedstock 104 resulting from the first extraction process can comprise less than 2% by mass of elastomeric polymers, less than 1% by mass of elastomeric polymers, less than 0.5% by mass of elastomeric polymers, or less than 0.2% by mass of elastomeric polymers. In addition, under the conditions specified herein for the first reaction process of method 100, the intermediate textile feedstock 104 resulting from the first extraction process can comprise all (100%) or substantially all (between 95% and 100%) of the polyester material and the cellulosic material included in the mixed textile feedstock 101.

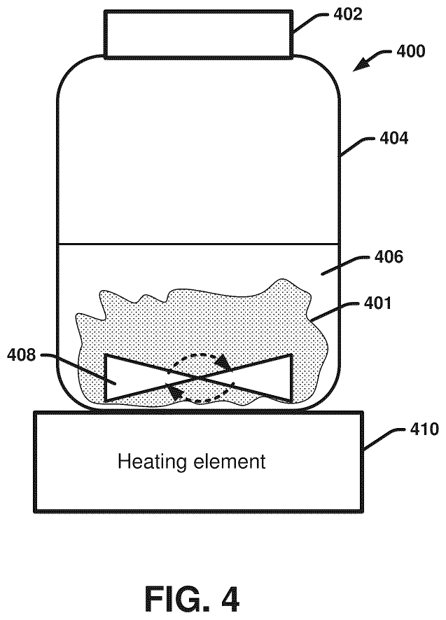

In various embodiments, the first extraction process at 102 can be performed as a batch process using extraction system 400 (or a similar extraction system) as described with reference to FIG. 4. With these embodiments, the mixed textile feedstock 101 and the solvent (in solution form) are placed within a vessel which is heated to the first temperature for a duration of time. The first temperature, the duration of time of the contacting, and the concentration of the solvent relative to the mixed textile feedstock 101 in the solution is selectively tailored to remove both the disperse colorant and the elastomeric polymers from the mixed textile feedstock 101 while preventing or minimizing the dissolution of the polyester material into the first mixture 103. In embodiments in which the first extraction process of method 100 is performed via extraction system 400 (or a similar system), in order to remove all (100%) or substantially all (between 95% and 100%) of the elastomeric polymers and the disperse colorant from the mixed textile feedstock 101 and retain all (100%) or substantially all (between 95% and 100%) of the polyester material and the cellulosic material in the intermediate textile feedstock 104, the first temperature is preferably between about 100° C. and 170° C., more preferably between 120° C. and 150° C., and even more preferably between 130° C. and 145° C.; the duration of time is preferably between about 1 minute and about 30 minutes, more preferably between about 4 minutes and about 20 minutes, and even more preferably between about 4 minutes and about 10 minutes; and the concentration of the solvent relative to the mixed textile feedstock in the solvent solution is about 1 part by mass of mixed textile feedstock 101 to about 50 parts by mass of solvent (e.g., a solvent-to-feedstock mass ratio of 50:1), about 1 part by mass of mixed textile feedstock 101 to about 20 parts by mass of solvent (e.g., a solvent-to-feedstock mass ratio of 20:1), about 1 part by mass of mixed textile feedstock 101 to about 10 parts by mass of solvent (e.g., a solvent-to-feedstock mass ratio of 10:1), or a solvent-to-feedstock mass ratio between about 10:1 and about 50:1.

In some implementations of the embodiments in which the first extraction process of method 100 is performed via extraction system 400 (or a similar system), in order to remove all (100%) or substantially all (between 95% and 100%) of the elastomeric polymers and the disperse colorant from the mixed textile feedstock 101 and retain all (100%) or substantially all (between 95% and 100%) of the polyester material and the cellulosic material in the intermediate textile feedstock 104, the “contacting” of the first extraction process may be performed over multiple (e.g., two or more) iterations or cycles. In such implementations, each iteration may utilize portion of fresh solvent at a selected solvent-to-feedstock mass ratio (e.g., 5:1, 10:1, or another suitable ratio), and the combined or cumulative effect of multiple extractions may achieve an effective overall solvent-to-feedstock ratio equivalent to a single larger-ratio extraction. For example, two consecutive extractions conducted at a 1:5 ratio may provide performance comparable to a single 1:10 extraction, and three 1:10 extractions may be viewed cumulatively as a 30:1 solvent-to-feedstock exposure. In such implementations, at each iteration or cycle of the contacting, the first temperature is preferably between about 100° C. and 170° C., more preferably between 120° C. and 150° C., and even more preferably between 130° C. and 145° C., and the duration of time is preferably between about 1 minute and about 30 minutes, more preferably between about 4 minutes and about 20 minutes, and even more preferably between about 4 minutes and about 10 minutes. Multiple iterations may improve extraction efficiency, reduce processing time, or better accommodate the thermal or volumetric constraints of the equipment used.

In some embodiments, the multiple-iteration approach may also include a final rinse or “chaser” step in which a smaller volume of fresh solvent is applied to the partially processed textile material (e.g., intermediate textile feedstock 104) to remove clinging or contaminated residual solvent and thereby enhance the purity of the resulting intermediate textile feedstock 104. The optimal number of extraction cycles, solvent volumes, and rinse steps may vary depending on equipment configuration, reactor volume, solvent heating characteristics, or fabric composition, and may be determined through process optimization.

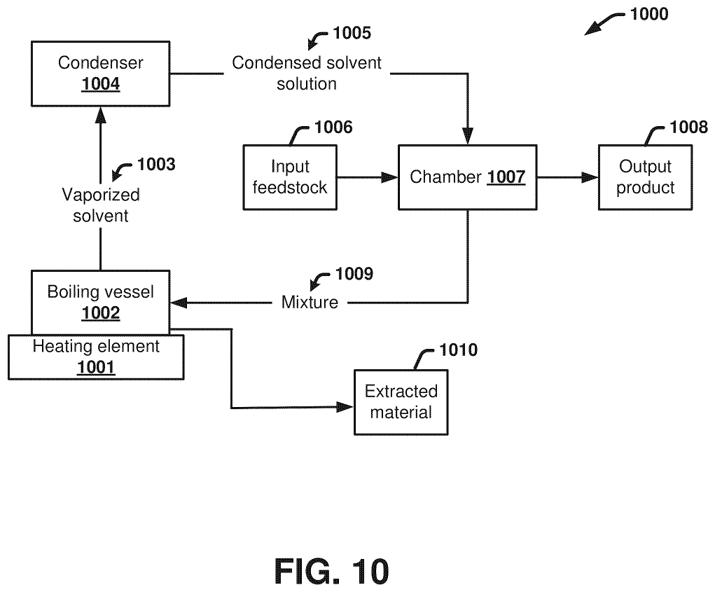

In other embodiments, the first extraction process at 102 can be performed using a continuous flow reaction system, as described with reference to FIGS. 10-14. With these embodiments, the mixed textile feedstock 101 is placed within a chamber for a duration of time and repeatedly contacted with the solvent solution over the duration of time, as heated to the first temperature, in a continuous or cyclical manner. With these embodiments, the heated solvent solution corresponds to a condensed solvent solution and/or a heated condensed solvent solution. In preferred embodiments, when the first extraction process of method 100 is performed using a continuous flow reaction system such as any system described with reference to FIGS. 10-14, in order to remove all (100%) or substantially all (between 95% and 100%) of the elastomeric polymers and the disperse colorant from the mixed textile feedstock 101 and retain all (100%) or substantially all (between 95% and 100%) of the polyester material and the cellulosic material in the intermediate textile feedstock 104, the first temperature is preferably between about 100° C. and 170° C., more preferably between 120° C. and 150° C., and even more preferably between 130° C. and 145° C.; the duration of time preferably between about 1 minute and about 60 minutes, more preferably between about 1 minute and about 30 minutes, and even more preferably between about 1 minute and about 15 minutes; and the concentration of the solvent relative to the mixed textile feedstock in the solvent solution is about 1 part by mass of mixed textile feedstock 101 to about 50 parts by mass of solvent (e.g., a solvent-to-feedstock mass ratio of 50:1), about 1 part by mass of mixed textile feedstock 101 to about 20 parts by mass of solvent (e.g., a solvent-to-feedstock mass ratio of 20:1), about 1 part by mass of mixed textile feedstock 101 to about 10 parts by mass of solvent (e.g., a solvent-to-feedstock mass ratio of 5:1), or a solvent-to-feedstock mass ratio between about 10:1 and about 50:1.

In some embodiments, at 105, method 100 may further comprise separating the disperse colorant, the elastomeric polymers and the solvent from the first mixture 103, resulting in (recovered) solvent 106, (recovered) disperse colorant 107, and (recovered) elastomeric polymers 108. The disperse colorants can be separated from the first mixture 103 by partial evaporation or cooling, or by selective dissolution away from the mixture using a different solvent, leaving purified elastomer. The (recovered) disperse colorant 107 may be used to dye additional materials. Likewise, the (recovered) elastomeric polymers 108 may be used in other products, including textile products and non-textile products.

In addition, the (recovered) solvent 106 may be reused in one or more of the extraction processes disclosed herein. For example, in some embodiments of method 100, as indicated via dashed arrow line 109a, the (recovered) solvent 106 may be used in the solution of the second extraction process at 110 in implementations in which the (recovered) solvent 106 has been purified via the separations step at 105 (or a downstream purification step). Additionally, or alternatively, as indicated via dashed line 109b, the (recovered) solvent 106 may be reused in another performance of the first extraction process at 102 as applied to the multiple iteration approach and/or additional mixed textile feedstock corresponding to the mixed textile feedstock 101. Still in other embodiments, in implementations in which the first extraction process is performed using a continuous flow reaction system, the (recovered) solvent 106 is repeatedly or continuously regenerated and reused over the duration of the first extraction process, as further described with reference to FIGS. 10-14.

At 110, method 100 further comprises extracting at least some of the polyester material from the intermediate textile feedstock 104 using a second extraction process, resulting in a purified cellulosic material 112 that excludes the at least some of the polyester material, the at least some of the disperse colorants and optical brighteners and the at least some of the elastomeric polymers, and a second mixture 111 comprising the solvent and the at least some of the polyester material, wherein the second extraction process comprises contacting the intermediate textile feedstock 104 to the solution in association with heating the solution to a second temperature higher than the first temperature. The second extraction process can also remove residual additive components (e.g., a lubricant agent, a perfluoroalkyl substance, a polyfluoroalkyl substance, a scouring agent, an anti-foam agent, a leveling agent, an antistatic compound, a water repellent, an emulsifier, a surfactant, a flame retardant, a wicking agent, dirt and grime, and combinations thereof) from the intermediate textile feedstock 104 that were not removed via the first extraction process.

To this end, the first extraction process performed at 102 and the second extraction process performed at 110 of method 100 use the same solvent in the solvent solution. It should be appreciated that the solvent solution used in the first extraction process at 102 and the solvent solution used in the second extraction processes at 110 respectively correspond to different (e.g., fresh) instances of the same solvent solution. In other words, the solution used in the first extraction process at 102 corresponds to a first solution and the solution used in the second extraction process at 110 corresponds to a second solution, wherein the solvent used in the first solution and the second solution is the same. The concentration of the solvent used in the first extraction process at 102 and the second extraction process at 110 may be the same or different. As noted above, in some implementations, the solvent can include a ketone and/or an ether. In various embodiments, the solvent is a cyclic ketone that comprises 5 to 10 carbon atoms. In some embodiments, the cyclic ketone comprises cyclopentanone, cyclohexanone or a combination thereof. In other embodiments, the solvent may comprise an ether, such as diphenyl ether. Still in other embodiments, the solvent can include cyclopentanone, cyclohexanone, diphenyl ether or a combination thereof.

For example, as noted above and indicated via dashed arrow line 109a, in some implementations, of method 100, the (recovered) solvent 106 as recovered from the first mixture 103 may be used to form the solvent solution of the second extraction process at 110. In other implementations, the solution of the second extraction process at 110 may be formed with a new or fresh instance of the same solvent, or alternatively, the solvent 106 can be backfed into previous extraction cycles 109b.

The conditions of the second extraction process performed at 110 can vary depending on the amount and type of polyester material included in the intermediate textile feedstock 104 and the desired amount of polyester material to be removed, the amount and type of cellulosic material included in the intermediate textile feedstock 101, the duration of contacting, the concentration of the solvent in the solution, and the second temperature to which the solution is heated (among other factors). These conditions can be tailored in accordance with the specifications described herein in order to remove all (100%) or substantially all (between 95% and 100%) of the polyester material from the intermediate textile feedstock 104. To this end, under the conditions specified herein for the second reaction process, the purified cellulosic material 112 resulting from the second extraction process can comprise less than 2% by mass of polyester material or less than 1% by mass of polyester material.

In this regard, the second temperature used in the second extraction process at 110 is preferably below the melting point of the polyester material yet sufficiently high to induce polyester phase mobility using the cyclic ketone solvent. Depending on the type of the polyester material (e.g., PET, PEN, PBT, PTT, etc.) the melting point of the polyester material may range between about 210° C. and about 270° C. In this regard, the second temperature may be between about 150° C. and about 210° C.-270° C. depending on the type of the polyester material. Under these conditions, the polyester domains of the intermediate textile feedstock 104 undergo segmental relaxation and amorphous-region swelling. The ester-linked polyester chains become more accessible to solvation by the cyclic ketone molecules, which penetrate and destabilize the polymer matrix. Under these conditions, the polyester material transitions from a solid fiber form into a solubilized or swollen polymer network within the solvent phase. The dissolved polyester forms a polymer-solvent solution (e.g., second mixture 111), whereas the cellulosic fibers, which do not appreciably swell or dissolve in the solvent, remain physically intact and mechanically separable.

In this regard, the cellulosic material remains insoluble because cellulose possesses a hydrogen-bonded β-1,4-glucan crystalline structure that is not disrupted by the non-aqueous cyclic ketone solvents disclosed herein. The hydroxyl-functional cellulose fibers do not undergo the molecular mobility transition necessary for dissolution and therefore retain their fibrous morphology during the dissolution of the polyester phase. As a result, the heated solution selectively removes the polyester material from the intermediate textile feedstock 104 while the cellulose fraction persists as an undissolved solid.

In various embodiments, the second extraction process at 110 can be performed as a batch process using extraction system 400 (or a similar extraction system) as described with reference to FIG. 4. With these embodiments, the intermediate textile feedstock 104 and the solvent (in solution form) are placed within a vessel which is heated to the second temperature for a duration of time. The second temperature is selectively tailored to remove (e.g., dissolve) the polyester material from the cellulosic material of the intermediate textile feedstock 104 while preventing or minimizing the degradation of the material properties of the cellulosic material. In preferred embodiments, in order to remove all (100%) or substantially all (between 95% and 100%) of the polyester material from the intermediate textile feedstock 104 via extraction system 400 (or a similar system), the second temperature is preferably between about 150° C. and 220° C., more preferably between 170° C. and 210° C., more preferably between 180° C. and 210° C., and even more preferably between 190° C. and 210° C.; the duration of time preferably between about 1 minute and about 30 minutes, more preferably between about 4 minutes and about 20 minutes, and even more preferably between about 4 minutes and about 10 minutes; and the concentration of the solvent relative to the intermediate textile feedstock 104 in the solvent solution is about 1 part by mass of intermediate textile feedstock 104 to about 50 parts by mass of solvent (e.g., a solvent-to-feedstock mass ratio of 50:1), about 1 part by mass of intermediate textile feedstock 104 to about 20 parts by mass of solvent (e.g., a solvent-to-feedstock mass ratio of 20:1), about 1 part by mass of intermediate textile feedstock 104 to about 10 parts by mass of solvent (e.g., a solvent-to-feedstock mass ratio of 10:1), or a solvent-to-feedstock mass ratio between about 10:1 and about 50:1.

In some implementations of the embodiments in which the second extraction process of method 100 is performed via extraction system 400 (or a similar system), in order to remove all (100%) or substantially all (between 95% and 100%) of the polyester material from the intermediate textile feedstock 104, the “contacting” of the second extraction process at 110 may be performed over multiple (e.g., two or more) iterations or cycles. In such implementations, each iteration may utilize portion of fresh solvent at a selected solvent-to-feedstock mass ratio (e.g., 5:1, 10:1, or another suitable ratio), and the combined or cumulative effect of multiple extractions may achieve an effective overall solvent-to-feedstock ratio equivalent to a single larger-ratio extraction. For example, two consecutive extractions conducted at a 1:5 ratio may provide performance comparable to a single 1:10 extraction, and three 1:10 extractions may be viewed cumulatively as a 30:1 solvent-to-feedstock exposure. In such implementations, at each iteration or cycle of the contacting, the second temperature is preferably between about 150° C. and 220° C., more preferably between 170° C. and 210° C., more preferably between 180° C. and 210° C., and even more preferably between 190° C. and 210° C., and the duration of time preferably between about 1 minute and about 30 minutes, more preferably between about 4 minutes and about 20 minutes, and even more preferably between about 4 minutes and about 10 minutes. Multiple iterations may improve extraction efficiency, reduce processing time, or better accommodate the thermal or volumetric constraints of the equipment used.

In some embodiments, the multiple-iteration approach may also include a final rinse or “chaser” step in which a smaller volume of fresh solvent is applied to the partially processed textile material to remove clinging or contaminated residual solvent and thereby enhance the purity of the resulting purified cellulosic material 112. The optimal number of extraction cycles, solvent volumes, and rinse steps may vary depending on equipment configuration, reactor volume, solvent heating characteristics, or fabric composition, and may be determined through process optimization.

In other embodiments, the second extraction process at 110 can be performed using a continuous flow reaction system, as described with reference to FIGS. 10-14. With these embodiments, the intermediate textile feedstock 104 is placed within a chamber for a duration of time and repeatedly contacted with the solvent solution over the duration of time, as heated to the second temperature, in a continuous or cyclical manner. With these embodiments, the heated solvent solution corresponds to a condensed solvent solution and/or a heated condensed solvent solution. In preferred embodiments, in order to remove all (100%) or substantially all (between 95% and 100%) of the polyester material from the intermediate textile feedstock 104 using a continuous flow reaction system described in FIGS. 10-14 (or a similar system), the second temperature is preferably between about 150° C. and 220° C., more preferably between 170° C. and 210° C., more preferably between 180° C. and 210° C., and even more preferably between 190° C. and 210° C.; the duration of time preferably between about 1 minute and about 60 minutes, more preferably between about 1 minute and about 30 minutes, and even more preferably between about 1 minute and about 15 minutes; and the concentration of the solvent relative to the intermediate textile feedstock 104 in the solvent solution is about 1 part by mass of intermediate textile feedstock 104 to about 50 parts by mass of solvent (e.g., a solvent-to-feedstock mass ratio of 50:1), about 1 part by mass of intermediate textile feedstock 104 to about 20 parts by mass of solvent (e.g., a solvent-to-feedstock mass ratio of 20:1), about 1 part by mass of intermediate textile feedstock 104 to about 10 parts by mass of solvent (e.g., a solvent-to-feedstock mass ratio of 10:1), or a solvent-to-feedstock mass ratio between about 10:1 and about 50:1.

To this end, one output of the second extraction process performed at 110 includes the purified cellulosic material 112 that excludes all (e.g., 100%), or substantially all (e.g., between 95% and 100%) of the polyester material included in the intermediate textile feedstock 104 and/or the mixed textile feedstock 101. In addition, as a result of the first extraction process performed at 110, the purified cellulosic material 112 excludes all (e.g., 100%), or substantially all (e.g., between 95% and 100%) of the disperse colorant and the elastomeric polymers and the included in the mixed textile feedstock 101.

In embodiments in which the mixed textile feedstock 101 also includes one or more fiber-reactive colorants, some (e.g., trace amounts) of these fiber-reactive colorants may be partially removed from the cellulosic component of the mixed textile feedstock 101 via the first and/or second extraction processes of method 100. However, the majority (e.g., between 95% and 100%) of these fiber-reactive colorants are not removed from the cellulosic material via the first and second extraction processes and thus remain bound thereto in the purified cellulosic material 112. In other words, in embodiments in which the mixed textile feedstock 101 also includes one or more fiber-reactive colorants, the purified cellulosic material 112 retains the one or more fiber-reactive colorants. This effect results in the recovered polyester material 114 excluding both the disperse colorant and any fiber-reactive colorants that may be included in the mixed textile feedstock 101 (in addition to the elastomeric polymers), rendering the recovered polyester material 114 suitable for recycling. The purified cellulosic material 112 may be reused in other products as is or further processed using existing techniques to remove fiber-reactive colorants therefrom (when applicable).

For example, in some embodiments, method 100 may further comprise transforming the purified cellulosic material 112 into a recycled cellulosic material via a recycling process. Suitable recycling processes may include, without limitation, mechanical fiber-recovery techniques (e.g., re-opening, carding, and re-spinning of the purified cotton fibers), chemical cellulose-regeneration pathways such as viscose, lyocell, or ion-cellulose dissolution routes, and enzymatic pretreatments configured to depolymerize or activate the cellulose for subsequent re-formation into regenerated fibers, films, or molded products. In other embodiments, the purified cotton may be incorporated directly into nonwoven substrates, insulation materials, or blended yarns, thereby enabling diversion of the cellulosic fraction into a wide variety of downstream textile and material-recovery applications.

At 113, method 100 may further comprise recovering the polyester material from the second mixture 111, resulting in (recovered) solvent 106 and recovered polyester material 114. In this regard, the second mixture 111 comprises a polyester-rich dissolution solution containing solubilized polyester chains within the solvent solution. At 113, the polyester material may be subsequently extracted or recovered from the second mixture 111 using one or more recovery techniques. The one or more recovery techniques can include polymer precipitation, antisolvent addition, temperature reduction, evaporation of the solvent, and/or pressurized solvent removal.

For example, in some embodiments the polyester is recovered from the second mixture 111 by cooling the second mixture 111 to a precipitation temperature between about 20° C. and about 130° C., thereby precipitating the polyester material 111 to form a precipitated polyester material (e.g., wherein the recovered polyester material 114 corresponds to the precipitated polyester material). Within this temperature range, the polyester in the second mixture 111 loses solubility, thereby inducing precipitation of a solid polyester product. In other embodiments, an antisolvent (e.g., water, an alcohol, or another miscible polar species) may be added to the polyester-rich solution to decrease polymer solubility and force polyester precipitation.

The resulting precipitated polyester material may form flakes, gels, granules, or amorphous solids. The precipitated polyester can be separated from the solvent phase by filtration, centrifugation, pressing, or other solid-liquid separation techniques. The recovered polyester material 114 may then be washed to remove any remaining residues. In addition, the (recovered) solvent 106 of the second mixture 111 may be recycled, distilled, or reused in subsequent extraction cycles as applied to the second extraction process (as indicted via dashed arrow line 115b) and/or the first extraction process (as indicated via dashed line 115a), and the recovered polyester material 114 may be recycled.

In this regard, at 116, method 100 may further comprise performing a recycling process to transform the recovered polyester material 114 into a recycled polyester material 117. In particular, because the recovered polyester material 114 resulting from method 100 is free or substantially free elastomeric polymers, colorant, and cellulosic material or dyed cellulosic material (and other additive substances discussed herein when included in the mixed textile feedstock 101), the recovered polyester material 114 can be efficiently transformed into a high-quality recycled material without additional pre-processing or post-processing steps. The recycling process can vary depending on the type of polyester material included in the recovered polyester material 114 and the desired type of recycled polyester material 117 to be obtained.

The recycling process performed at 116 can include any existing or future developed mechanical or chemical recycling process applicable to polyester material. Suitable chemical recycling processes include hydrolysis or solvolysis processes such as methanolysis. Another example of an applicable recycling process that may be performed at 116 on the recovered polyester material 114 comprises a chemical recycling process using glycolysis. In some implementations of these embodiments, the recycling process comprises transforming the PET into Bis(2-hydroxyethyl)terephthalate (BHET) using glycolysis, and repolymerizing the BHET to form the recycled polyester material. In various embodiments, the glycolysis-based recycling process corresponds to the volatile catalyst (VolCat) method described in U.S. Pat. No. 9,255,194 B2 to Allen et al. and U.S. Pat. No. 9,914,816 B2 to Allen et al. The VolCat process depolymerizes PET rapidly via glycolysis using an organocatalyst into the molecule Bis(2-hydroxyethyl)terephthalate (BHET), which can be repolymerized into the recycled polyester material 117.

Method 100 and other methods disclosed herein thus provide the necessary pre-treatment step to remove elastomeric polymers, colorant, cotton or dyed cotton, and other additive substances from PET and other polyester materials prior to depolymerization via glycolysis, thus greatly extending the application of the VolCat process and other textile polymer recycling process to textiles and fabrics currently being landfilled or incinerated. Additionally, method 100 and additional processes described herein provide techniques to recover the colorants, the elastomers, and cellulosic components of the mixed textile feedstock 101 individually for reuse and valorization.

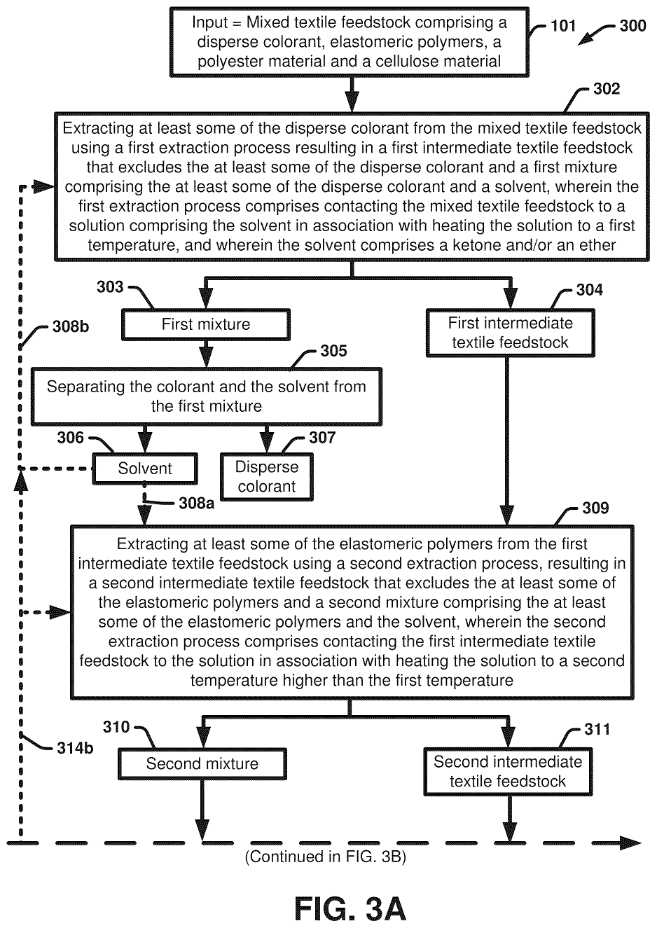

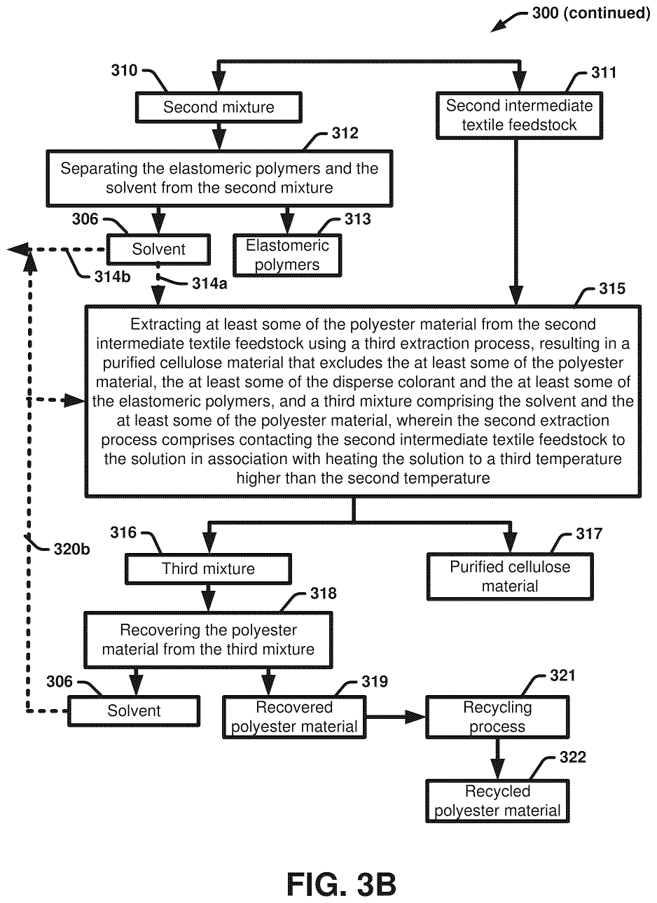

FIGS. 3A and 3B illustrate a flow diagram of another example, non-limiting method 300 for selectively removing components of a mixed textile feedstock, in accordance with one or more embodiments described herein. The input to method 300 comprises the mixed textile feedstock 101 described with reference to FIG. 1 and method 100. Repetitive description of like elements employed in respective embodiments is omitted for sake of brevity. Method 300 differs from method 100 with the usage of three separate extraction processes, a first process applied to selectively remove the disperse colorant, a second process to selectively remove the elastomeric polymers, and a third process to selectively remove the polyester material.

At 302, method 300 comprises extracting at least some of the disperse colorant (e.g., one or more disperse dyes, pigments, brightener agents, and/or other types of disperse colorants) from the mixed textile feedstock 101 using a first extraction process resulting in a first intermediate textile feedstock 304 that excludes the at least some of the disperse colorant (yet retains the elastomeric polymers, the polyester material, and the cellulose material), and a first mixture 303 comprising the at least some of the disperse colorant and a solvent, wherein the first extraction process comprises contacting the mixed textile feedstock 101 to a solution comprising the solvent in association with heating the solution to a first temperature, and wherein the solvent comprises a ketene and/or an ether.

In accordance with the illustrated embodiment of method 300, the solvent used in the first second and third extraction processes is the same. In various embodiments, the solvent is a cyclic ketone that comprises 5 to 10 carbon atoms. In some embodiments, the cyclic ketone comprises cyclopentanone, cyclohexanone or a combination thereof. In other embodiments, the solvent may comprise an ether, such as diphenyl ether. Still in other embodiments, the solvent can include cyclopentanone, cyclohexanone, diphenyl ether or a combination thereof.

However, in other embodiments, the selective removal of disperse dyes and other disperse colorants from the polyester component of the mixed textile feedstock 101 can be achieved using a solvent comprising an alcohol, an ether, an ester, a ketone or a combination thereof. In particular, the solvent used in the first extraction process at 302 may include, (but not limited to) cyclobutanone, cyclopentanone, cyclohexanone, 1,4-dioxane, 1,3-dioxolane, tetrahydrofuran, 2-methyl tetrahydrofuran, dimethyl carbonate, diethyl carbonate, ethyl lactate, ethyl acetate, or a combination thereof.

The conditions of the first reaction process performed at 302 can vary depending on the amount and type of disperse colorant included in the mixed textile feedstock 101, the desired amount of disperse colorant to be removed, the duration of contacting, the concentration of the solvent, and the first temperature to which the solution is heated (among other factors). These conditions can be tailored in accordance with the specifications described herein in order to selectively remove all (100%) or substantially all (between 95% and 100%) of the disperse colorant from the mixed textile feedstock 101, regardless of the amount of the type and amount of disperse colorant in the mixed textile feedstock 101, yet retain the all (100%) or substantially all (between 95% and 100%) of the elastomeric polymers, the polyester material and the cellulose material in the first intermediate textile feedstock 304. To this end, under the conditions specified herein for the first reaction process of method 300, the intermediate textile feedstock 304 resulting from the first extraction process can comprise less than 2% by mass of disperse colorant, less than 1% by mass of disperse colorant, less than 0.5% by mass of disperse colorant, or less than 0.2% by mass of disperse colorant, yet comprises all (100%) or substantially all (between 95% and 100%) of the elastomeric polymers, the polyester material and the cellulose material of the mixed textile feedstock 101.

In some embodiments in which the mixed textile feedstock 101 includes one or more other additive components (e.g., a lubricant agent, a perfluoroalkyl substance, a polyfluoroalkyl substance, a scouring agent, an anti-foam agent, a leveling agent, an antistatic compound, a water repellent, an emulsifier, a surfactant, a flame retardant, a wicking agent, dirt and grime, and combinations thereof), at least some of these additive components are also removed from the mixed textile feedstock 101 as a result of the first extraction process performed at 302.

In various embodiments, the first extraction process at 302 can be performed as a batch process using extraction system 400 (or a similar extraction system) as described with reference to FIG. 4. With these embodiments, the mixed textile feedstock 101 and the solvent (in solution form) are placed within a vessel which is heated to the first temperature for a duration of time. The first temperature and the duration of time are selectively tailored to remove all (100%) or substantially all (between 95% and 100%) of the disperse colorant from the mixed textile feedstock 101 (and other additives disclosed herein when included in the mixed textile feedstock 101) while preventing or minimizing the dissolution of the elastomeric polymers and the polyester material into the first mixture 303. To achieve this in the batch process implementation of the first extraction process performed at 302, the first temperature is preferably between about 50° C. and 120° C., more preferably between 60° C. and 110° C., and even more preferably between 70° C. and 100° C.; the duration of time preferably between about 1 minute and about 30 minutes, more preferably between about 2 minutes and about 20 minutes, and even more preferably between about 4 minutes and about 6 minutes; and the concentration of the solvent relative to the mixed textile feedstock 101 in the solvent solution is about 1 part by mass of mixed textile feedstock 101 to about 30 parts by mass of solvent (e.g., a solvent-to-feedstock mass ratio of 20:1), about 1 part by mass of mixed textile feedstock 101 to about 20 parts by mass of solvent (e.g., a solvent-to-feedstock mass ratio of 10:1), about 1 part by mass of mixed textile feedstock 101 to about 10 parts by mass of solvent (e.g., a solvent-to-feedstock mass ratio of 5:1), or a solvent-to-feedstock mass ratio between about 1:1 and about 30:1.

In some implementations of the embodiments in which the first extraction process of method 300 is performed via extraction system 400 (or a similar system), in order to remove all (100%) or substantially all (between 95% and 100%) of the disperse colorant from the mixed textile feedstock 101 and retain all (100%) or substantially all (between 95% and 100%) of the elastomeric polymers, the polyester material and the cellulosic material in the first intermediate textile feedstock 304, the “contacting” of the first extraction process at 302 may be performed over multiple (e.g., two or more) iterations or cycles. In such implementations, each iteration may utilize portion of fresh solvent at a selected solvent-to-feedstock mass ratio (e.g., 5:1, 10:1, or another suitable ratio), and the combined or cumulative effect of multiple extractions may achieve an effective overall solvent-to-feedstock ratio equivalent to a single larger-ratio extraction. For example, two consecutive extractions conducted at a 1:5 ratio may provide performance comparable to a single 1:10 extraction, and three 1:10 extractions may be viewed cumulatively as a 30:1 solvent-to-feedstock exposure. In such implementations, at each iteration or cycle of the contacting, the first temperature is preferably between about 50° C. and 120° C., more preferably between 60° C. and 110° C., and even more preferably between 70° C. and 100° C., and the duration of time preferably between about 1 minute and about 30 minutes, more preferably between about 2 minutes and about 20 minutes, and even more preferably between about 4 minutes and about 6 minutes. Multiple iterations may improve extraction efficiency, reduce processing time, or better accommodate the thermal or volumetric constraints of the equipment used.

In other embodiments, the first extraction process at 302 can be performed using a continuous flow reaction system, as described with reference to FIGS. 10-15. With these embodiments, the mixed textile feedstock 101 is placed within a chamber for a duration of time and repeatedly contacted with the solvent solution over the duration of time, as heated to the first temperature, in a continuous or cyclical manner. With these embodiments, the heated solvent solution corresponds to a condensed solvent solution and/or a heated condensed solvent solution. The conditions of the first reaction are again selectively tailored to remove all (100%) or substantially all (between 95% and 100%) of the disperse colorant from the mixed textile feedstock 101 (and other additives disclosed herein when included in the mixed textile feedstock 101) while preventing or minimizing the dissolution of the elastomeric polymers and the polyester material into the first mixture 303. To achieve this in the continuous flow reaction process implementation of the first extraction process at 302, the first temperature is preferably between about 50° C. and 120° C., more preferably between about 60° C. and 110° C., and even more preferably between 70° C. and 100° C.; the duration of time preferably between about 1 minute and about 60 minutes, more preferably between about 1 minute and about 30 minutes, and even more preferably between about 1 minute and about 15minutes; and the concentration of the solvent relative to the mixed textile feedstock 101 in the solvent solution is about 1 part by mass of mixed textile feedstock 101 to about 30 parts by mass of solvent (e.g., a solvent-to-feedstock mass ratio of 30:1), about 1 part by mass of mixed textile feedstock 101 to about 20 parts by mass of solvent (e.g., a solvent-to-feedstock mass ratio of 20:1), about 1 part by mass of mixed textile feedstock 101 to about 10 parts by mass of solvent (e.g., a solvent-to-feedstock mass ratio of 10:1), or a solvent-to-feedstock mass ratio between about 10:1 and about 30:1.

In some embodiments, at 305, method 100 may further comprise separating the disperse colorant, and the solvent from the first mixture 303, resulting in (recovered) solvent 306, and (recovered) disperse colorant 307. For example, this may be accomplished by subjecting the first mixture 303 to a phase-separation operation such as filtration, centrifugal separation, pressurized solvent removal, distillation, or controlled evaporation of the solvent. The (recovered) disperse colorant 307 may be used to dye additional materials. In addition, the (recovered) solvent 306 may be reused in one or more of the extraction processes disclosed herein. For example, in some embodiments of method 300, as indicated via dashed arrow line 308a, the (recovered) solvent 306 may be used in the solution of the second extraction process at 309. Additionally, or alternatively, as indicated via dashed arrow line 308b, the (recovered) solvent 306 may be reused in another performance of the first extraction process at 302 as applied to the mixed textile feedstock 101 or additional mixed textile feedstock corresponding to the mixed textile feedstock 101. Still in other embodiments, in implementations in which the first extraction process is performed using a continuous flow reaction system, the (recovered) solvent 306 is repeatedly or continuously regenerated and reused over the duration of the first extraction process, as further described with reference to FIGS. 10-15.

At 309, method 300 comprises extracting at least some of the elastomeric polymers from the first intermediate textile feedstock 304 using a second extraction process, resulting in a second intermediate textile feedstock 311 that excludes the at least some of the elastomeric polymers (and retains the polyester material and the cellulose material) and a second mixture 310 comprising the at least some of the elastomeric polymers and the solvent, wherein the second extraction process comprises contacting the first intermediate textile feedstock 304 to the solution in association with heating the solution to a second temperature higher than the first temperature.

As noted above, in accordance with the illustrated embodiment of method 300, the solvent used in the first second and third extraction processes is the same. To this end, the first extraction process performed at 302, the second extraction process performed at 309, and the third extraction process performed at 315 of method 300 use the same solvent in the solvent solution. It should be appreciated that the solvent solution used in the first extraction process at 302, the solvent solution used in the second extraction processes at 309, and the solvent solution used in the third extraction process at 315, respectively correspond to different (e.g., fresh) instances of the same solvent solution. In other words, the solution used in the first extraction process at 302 corresponds to a first solution, the solution used in the second extraction process at 309 corresponds to a second solution, and the solution used in the third extraction process at 315 corresponds to a third solution, wherein the solvent used in the first solution, the second solution and the third solution, is the same. The concentration of the solvent used in the first extraction process at 302, the second extraction process at 309 and the third extraction process at 315, may be the same or different. As noted above, in some implementations, the solvent can include a ketone and/or an ether. In various embodiments, the solvent is a cyclic ketone that comprises 5 to 10 carbon atoms. In some embodiments, the cyclic ketone comprises cyclopentanone, cyclohexanone or a combination thereof. In other embodiments, the solvent may comprise an ether, such as diphenyl ether. Still in other embodiments, the solvent can include cyclopentanone, cyclohexanone, diphenyl ether or a combination thereof.

The conditions of the second extraction process performed at 309 can vary depending on the amount and type of elastomeric polymers included in the first intermediate textile feedstock 304, the desired amount of elastomeric polymers to be removed, the amount and type of polyester material included, the duration of contacting, the concentration of the solvent, and the second temperature to which the solution is heated (among other factors). In various embodiments, the conditions of the second extraction process performed at 309 can be tailored in accordance with the specifications described herein in order to selectively remove all (100%) or substantially all (between 95% and 100%) of the elastomeric polymers from the first intermediate textile feedstock 304, regardless of the amount of the type and amount and type of the elastomeric polymers included in the mixed textile feedstock 101, yet retain the polyester component and the cellulosic component in the second intermediate textile feedstock 311. To this end, under the conditions specified herein for the second reaction process of method 300, the second intermediate textile feedstock 311 resulting from the second extraction process can comprise less than 2% by mass of elastomeric polymers, less than 1% by mass of elastomeric polymers, less than 0.5% by mass of elastomeric polymers, or less than 0.2% by mass of elastomeric polymers, and further comprise all (100%) or substantially all (between 95% and 100%) of the polyester material and the cellulosic material included in the mixed textile feedstock 101 and/or the first intermediate textile feedstock 304.

In various embodiments, the second extraction process at 309 can be performed as a batch process using extraction system 400 (or a similar extraction system) as described with reference to FIG. 4. With these embodiments, the first intermediate textile feedstock 304 and the solvent (in solution form) are placed within a vessel which is heated to the second temperature for a duration of time. The second temperature and the duration of time are selectively tailored to remove all (100%) or substantially all (between 95% and 100%) of the elastomeric polymers from the first intermediate textile feedstock 304 (and other additives disclosed herein when included in the mixed textile feedstock 101) while preventing or minimizing the dissolution of the polyester material into the second mixture 310. To achieve this in the batch process implementation of the second extraction process performed at 309, the second temperature is preferably between about 110° C. and 170° C., more preferably between 120° C. and 150° C., and even more preferably between 130° C. and 145° C.; the duration of time preferably between about 1 minute and about 30 minutes, more preferably between about 4 minutes and about 20 minutes, and even more preferably between about 4 minutes and about 6 minutes; and the concentration of the solvent relative to the first intermediate textile feedstock 304 in the solvent solution is about 1 part by mass of first intermediate textile feedstock 304 to about 50 parts by mass of solvent (e.g., a solvent-to-feedstock mass ratio of 50:1), about 1 part by mass of first intermediate textile feedstock 304 to about 20 parts by mass of solvent (e.g., a solvent-to-feedstock mass ratio of 20:1), about 1 part by mass of first intermediate textile feedstock 304 to about 10 parts by mass of solvent (e.g., a solvent-to-feedstock mass ratio of 10:1), or a solvent-to-feedstock mass ratio between about 10:1 and about 50:1.

In some implementations of the embodiments in which the second extraction process of method 300 is performed via extraction system 400 (or a similar system), in order to remove all (100%) or substantially all (between 95% and 100%) of the elastomeric polymers from the first intermediate textile feedstock 304 and retain all (100%) or substantially all (between 95% and 100%) of the polyester material and the cellulosic material in the second intermediate textile feedstock 311, the “contacting” of the second extraction process may be performed over multiple (e.g., two or more) iterations or cycles. In such implementations, each iteration may utilize portion of fresh solvent at a selected solvent-to-feedstock mass ratio (e.g., 5:1, 10:1, or another suitable ratio), and the combined or cumulative effect of multiple extractions may achieve an effective overall solvent-to-feedstock ratio equivalent to a single larger-ratio extraction. For example, two consecutive extractions conducted at a 1:5 ratio may provide performance comparable to a single 1:10 extraction, and three 1:10 extractions may be viewed cumulatively as a 30:1 solvent-to-feedstock exposure. In such implementations, at each iteration or cycle of the contacting, the second temperature is preferably between about 110° C. and 170° C., more preferably between 120° C. and 150° C., and even more preferably between 130° C. and 145° C.; the duration of time preferably between about 1 minute and about 30 minutes, more preferably between about 4 minutes and about 20 minutes, and even more preferably between about 4 minutes and about 6 minutes. Multiple iterations may improve extraction efficiency, reduce processing time, or better accommodate the thermal or volumetric constraints of the equipment used.

In other embodiments, the second extraction process at 309 can be performed using a continuous flow reaction system, as described with reference to FIGS. 10-15. With these embodiments, the first intermediate textile feedstock 304 is placed within a chamber for a duration of time and repeatedly contacted with the solvent solution over the duration of time, as heated to the first temperature, in a continuous or cyclical manner. With these embodiments, the heated solvent solution corresponds to a condensed solvent solution and/or a heated condensed solvent solution. As noted above, the second temperature and the duration of time are selectively tailored to remove all (100%) or substantially all (between 95% and 100%) of the elastomeric polymers from the first intermediate textile feedstock 304 (and other additives disclosed herein when included in the mixed textile feedstock 101) while preventing or minimizing the dissolution of the polyester material into the second mixture 310. To achieve this in the continuous flow reaction process implementation of the second extraction process performed at 309, the second temperature is preferably between about 110° C. and 170° C., more preferably between 120° C. and 150° C., and even more preferably between 130° C. and 145° C.; the duration of time preferably between about 1 minute and about 60 minutes, more preferably between about 1 minute and about 30 minutes, and even more preferably between about 1 minute and about 15 minutes; and the concentration of the solvent relative to the first intermediate textile feedstock 304 in the solvent solution is about 1 part by mass of first intermediate textile feedstock 304 to about 50 parts by mass of solvent (e.g., a solvent-to-feedstock mass ratio of 50:1), about 1 part by mass of first intermediate textile feedstock 304 to about 20 parts by mass of solvent (e.g., a solvent-to-feedstock mass ratio of 20:1), about 1 part by mass of first intermediate textile feedstock 304 to about 10 parts by mass of solvent (e.g., a solvent-to-feedstock mass ratio of 10:1), or a solvent-to-feedstock mass ratio between about 10:1 and about 50:1.

Continuing to FIG. 3B, in some embodiments, at 312, method 300 may further comprise separating the elastomeric polymers, and the solvent from the second mixture 310, resulting in (recovered) solvent 306, and (recovered) elastomeric polymers 313. For example, this may be accomplished by subjecting the second mixture 310 to a phase-separation operation such as filtration, centrifugal separation, pressurized solvent removal, or controlled evaporation of the solvent. In certain embodiments, the elastomeric polymers, whether present as dissolved species, swollen fragments, or particulate residues, may be collected on a filter or porous medium while the solvent passes through. In other embodiments, at least a portion of the solvent may be evaporated or distilled, thereby concentrating the elastomeric polymer fraction into a solid or semi-solid residue while generating purified solvent 306 suitable for reuse in upstream extraction steps.

In some embodiments, the second mixture 310 may be transferred under pressure into a receiving vessel and allowed to cool to a temperature at which the elastomeric polymer loses solubility, thereby facilitating subsequent isolation via filtration or settling. In still other embodiments, addition of an antisolvent (e.g., water or a polar alcohol) may optionally be used to reduce the solubility of polyurethane or other elastomeric species in the solvent, promoting precipitation and enabling their recovery as elastomeric polymers 313.

The (recovered) elastomeric polymers 313 may be reused in other materials. In addition, the (recovered) solvent 306 may be reused in one or more of the extraction processes disclosed herein. For example, in some embodiments of method 300, as indicated via dashed arrow line 314a, the (recovered) solvent 306 may be used in the solution of the third extraction process at 315. Additionally, or alternatively, as indicated via dashed arrow line 314b, the (recovered) solvent 306 may be reused in repeated or additional performances of any of the previous extraction processes of method 300. For example, the recovered solvent 306 may used in another performance of the second extraction process at 309 and/or another performance of the first extraction process at 302.

At 315, method 300 further comprises extracting at least some of the polyester material from the second intermediate textile feedstock 311 using a third extraction process, resulting in a purified cellulosic material 317 that excludes the at least some of the polyester material (in addition to the at least some of the disperse colorant and the at least some of the elastomeric polymers), and a third mixture 316 comprising the solvent and the at least some of the polyester material, wherein the third extraction process comprises contacting the second intermediate textile feedstock 311 to the solution in association with heating the solution to a third temperature higher than the first temperature. To this end, third extraction process at 315 of method 100 uses the same solvent solution (e.g., or more particularly a fresh or recycled instance of the same solvent solution) used in the second and first extraction process of method 300.

The conditions of the third extraction process at 315 are tailored in accordance with the specifications described herein in order to selectively remove all (100%) or substantially all (between 95% and 100%) of the polyester material form the second intermediate textile feedstock 311, regardless of the amount of the type and amount and type of the polyester material included in the second intermediate textile feedstock 311, thereby rendering isolated or purified cellulosic material 317. To this end, under the conditions specified herein for the third reaction process of method 300, the purified cellulose material 317 resulting from the third extraction process can comprise less than 2% by mass of the combination of elastomeric polymers, disperse colorant and polyester material, less than 1% by mass of the combination of elastomeric polymers, disperse colorant and polyester material, less than 0.5% by mass of elastomeric polymers, or less than 0.2% by mass of the combination of elastomeric polymers, disperse colorant and polyester material.

In addition, as described with reference to 110 of method 100, in embodiments in which the mixed textile feedstock 101 also includes one or more fiber-reactive colorants, these fiber-reactive colorants are not removed from the cellulosic material via the first, second and third extraction processes and thus remain bound thereto in the purified cellulosic material 317. In other words, in embodiments in which the mixed textile feedstock 101 also includes one or more fiber-reactive colorants, the purified cellulosic material 317 retains all (e.g., 100%) or substantially all (e.g., between 95% and 100%) of the one or more fiber-reactive colorants. This effect results in the recovered polyester material 319 excluding both the disperse colorant and any fiber-reactive colorants that may be included in the mixed polyester material 101 (in addition to the elastomeric polymers), rendering the recovered polyester material 319 suitable for recycling.

In various embodiments, the third extraction process at 315 can be performed as a batch process using extraction system 400 (or a similar extraction system) as described with reference to FIG. 4. With these embodiments, the second intermediate textile feedstock 311 and the solvent are placed within a vessel which is heated to the third temperature for a duration of time. As noted above, the reaction conditions are selectively tailored to remove or dissolve all (100%) or substantially all (between 95% and 100%) of the elastomeric polymers from the cellulosic material of the second intermediate textile feedstock 311 while preventing or minimizing the degradation of the material properties of the cellulosic material. To achieve this in the batch process implementation the third temperature is preferably between about 150° C. and 250° C., more preferably between 170° C. and 220° C., more preferably between 180° C. and 210° C., and even more preferably between 190° C. and 210° C.; the duration of time preferably between about 1 minute and about 30 minutes, more preferably between about 4 minutes and about 20 minutes, and even more preferably between about 4 minutes and about 10 minutes; and the concentration of the solvent relative to the second intermediate textile feedstock 311 in the solvent solution is about 1 part by mass of second intermediate textile feedstock 311 to about 50 parts by mass of solvent (e.g., a solvent-to-feedstock mass ratio of 50:1), about 1 part by mass of second intermediate textile feedstock 311 to about 20 parts by mass of solvent (e.g., a solvent-to-feedstock mass ratio of 20:1), about 1 part by mass of mixed textile feedstock 101 to about 10 parts by mass of solvent (e.g., a solvent-to-feedstock mass ratio of 10:1), or a solvent-to-feedstock mass ratio between about 10:1 and about 50:1.

In some implementations of the embodiments in which the third extraction process of method 300 is performed via extraction system 400 (or a similar system), in order to remove all (100%) or substantially all (between 95% and 100%) of the polyester material from the second intermediate textile feedstock 311, the “contacting” of the third extraction process at 315 may be performed over multiple (e.g., two or more) iterations or cycles. In such implementations, each iteration may utilize portion of fresh solvent at a selected solvent-to-feedstock mass ratio (e.g., 5:1, 10:1, or another suitable ratio), and the combined or cumulative effect of multiple extractions may achieve an effective overall solvent-to-feedstock ratio equivalent to a single larger-ratio extraction. For example, two consecutive extractions conducted at a 1:5 ratio may provide performance comparable to a single 1:10 extraction, and three 1:10 extractions may be viewed cumulatively as a 30:1 solvent-to-feedstock exposure. In such implementations, at each iteration or cycle of the contacting, the third temperature is preferably between about 150° C. and 220° C., more preferably between 170° C. and 210° C., more preferably between 180° C. and 210° C., and even more preferably between 190° C. and 210° C., and the duration of time preferably between about 1 minute and about 30 minutes, more preferably between about 4 minutes and about 20 minutes, and even more preferably between about 4 minutes and about 10 minutes. Multiple iterations may improve extraction efficiency, reduce processing time, or better accommodate the thermal or volumetric constraints of the equipment used.

In other embodiments, the third extraction process at 315 can be performed using a continuous flow reaction system, as described with reference to FIGS. 10-15. With these embodiments, the second intermediate textile feedstock 311 is placed within a chamber for a duration of time and repeatedly contacted with the solvent solution over the duration of time, as heated to the second temperature, in a continuous or cyclical manner. With these embodiments, the heated solvent solution corresponds to a condensed solvent solution and/or a heated condensed solvent solution. In some implementations of these embodiments, as applied to removing all (100%) or substantially all (between 95% and 100%) of the polyester material from the second intermediate textile feedstock 311 using a continuous flow reaction system, the third temperature is preferably between about 150° C. and 250° C., more preferably between 170° C. and 210° C., more preferably between 180° C. and 210° C., and even more preferably between 190° C. and 210° C.; the duration of time preferably between about 1 minute and about 60 minutes, more preferably between about 1 minute and about 30 minutes, and even more preferably between about 1 minute and about 15 minutes; and the concentration of the solvent relative to the second intermediate textile feedstock 311 in the solvent solution is about 1 part by mass of second intermediate textile feedstock 311 to about 50 parts by mass of solvent (e.g., a solvent-to-feedstock mass ratio of 50:1), about 1 part by mass of second intermediate textile feedstock 311 to about 20 parts by mass of solvent (e.g., a solvent-to-feedstock mass ratio of 20:1), about 1 part by mass of second intermediate textile feedstock 311 to about 10 parts by mass of solvent (e.g., a solvent-to-feedstock mass ratio of 10:1), or a solvent-to-feedstock mass ratio between about 10:1 and about 50:1.

To this end, one output of the third extraction process performed at 315 includes the purified cellulosic material 317 that excludes all, or substantially all (such that the purified cellulosic material 317 comprises less than 1% or 2%), of the disperse colorant, the elastomeric polymers and the polyester material relative to the mixed textile feedstock 101. In embodiments in which the mixed textile feedstock 101 also includes one or more fiber-reactive colorants, some (e.g., trace amounts) of these fiber-reactive colorants may be partially removed from the cellulosic component of the mixed textile feedstock via the first, second and/or third extraction processes. However, the majority of these fiber-reactive colorants are not removed from the cellulosic material via the first, second, and/or third extraction processes and thus remain bound thereto in the purified cellulosic material 317. In other words, in embodiments in which the mixed textile feedstock 101 also includes one or more fiber-reactive colorants, the purified cellulosic material 317 retains the one or more fiber-reactive colorants. This effect results in the recovered polyester material 319 excluding both the disperse colorant and any fiber-reactive colorants that may be included in the mixed polyester material 101 (in addition to the elastomeric polymers), rendering the recovered polyester material 319 suitable for recycling.

The purified cellulosic material 317 may be reused in other products as is or further processed using existing techniques to remove fiber-reactive colorants therefrom (when applicable) or to make MMCF's. For example, in some embodiments, method 300 may further comprise transforming the purified cellulosic material 317 into a recycled cellulosic material via a recycling process. Suitable recycling processes may include, without limitation, mechanical fiber-recovery techniques (e.g., re-opening, carding, and re-spinning of the purified cotton fibers), chemical cellulose-regeneration pathways such as viscose, lyocell, or ion-cellulose dissolution routes, and enzymatic pretreatments configured to depolymerize or activate the cellulose for subsequent re-formation into regenerated fibers, films, or molded products. In other embodiments, the purified cotton may be incorporated directly into nonwoven substrates, insulation materials, or blended yarns, thereby enabling diversion of the cellulosic fraction into a wide variety of downstream textile and material-recovery applications.

A second output of the third extraction process performed at 309 can include the third mixture 316, which corresponds to a polyester-solvent solution. At 318, method 300 may further comprise recovering the polyester material from the third mixture 316, resulting in (recovered) solvent 306 and recovered polyester material 319. This process corresponds to the recovery process performed at 113 relative to the second mixture 111 in process 100 (e.g., polyester precipitation by cooling the third mixture to a temperature between about 20° C. and 130° C.). Repetitive description is therefore omitted for sake of brevity. As indicated via dashed arrow line 320b, the (recovered) solvent 306 may once again be reused in repeated or additional performances of any of the extraction processes disclosed herein.

At 321, method 300 may further comprise performing a recycling process to transform the recovered polyester material 319 into a recycled polyester material 322. In particular, because the recovered polyester material 319 resulting from method 300 is free or substantially free elastomeric polymers, colorant, and cellulosic material or dyed cellulosic material (and other additive substances discussed herein when included in the mixed textile feedstock 101), the recovered polyester material 319 can be efficiently transformed into a high-quality recycled material without additional pre-processing or minimal post-processing steps. The recycling process can vary depending on the type of polyester material included in the recovered polyester material 319 the desired type of recycled polyester material 322 to be obtained.

The recycling process performed at 321 can include any existing or future developed mechanical or chemical recycling process applicable to polyester material. Suitable chemical recycling processes include hydrolysis or solvolysis processes such as methanolysis. Another example of an applicable recycling process that may be performed at 321 on the recovered polyester material 319 comprises a chemical recycling process using glycolysis. In some implementations of these embodiments, the recycling process comprises transforming the PET into Bis(2-hydroxyethyl)terephthalate (BHET) using glycolysis, and repolymerizing the BHET to form the recycled polyester material. In various embodiments, the glycolysis-based recycling process corresponds to the volatile catalyst (VolCat) method described in U.S. Pat. No. 9,255,194 B2 to Allen et al. and U.S. Pat. No. 9,914,816 B2 to Allen et al. The VolCat process depolymerizes PET rapidly via glycolysis using an organocatalyst into the molecule Bis(2-hydroxyethyl)terephthalate (BHET), which can be repolymerized into the recycled polyester material 322.

FIG. 4 presents an example, non-limiting batch process extraction system (hereinafter system 400), in accordance with one or more embodiments described herein. System 400 includes heating element 410 and a vessel 404 comprising an enclosure 402 (a lid or the like) and a stirring apparatus 408 (which may be removed in some implementations). In some embodiments, extraction system 400 can include or correspond to a high-pressure batch reactor, such as a Parr high-pressure batch reactor manufactured by the company Parr Instrument Company or a similar high pressure batch reactor adapted for processing large amounts of polyester material on an industrialized level. High-pressure batch reactors operate as a closed system, meaning reactants are loaded into the vessel and sealed before the reaction and products are removed after completion. In other embodiments, extraction system 400 can include or correspond to an open system (e.g., performed under ambient pressure). In some implementations, the stirring apparatus 408 can include or correspond to a magnetic or mechanical stirring apparatus. In other implementations, other means of mechanical agitation for uniform mixing of reactants may be used.

The heating element 410 can include or correspond to an electrical heater or external jacket that provides for precise temperature control and may include cooling coils for rapid temperature control adjustments. In some embodiments in which reaction system 400 corresponds to a high-pressure batch reactor, the reaction system 400 can includes a gas introduction apparatus (not shown) that allows for controlled gas injection (e.g., nitrogen, oxygen, hydrogen, etc.) for reactions requiring pressurized or inert gases.

With reference to FIG. 4 in view of FIGS. 1-4, as noted above, in some embodiments, one or more of the extraction processes of method 100 and method 300 may be performed using system 400 (or a similar system). With these embodiments, the input textile feedstock 401 may correspond to mixed textile feedstock 101, intermediate textile feedstock 104, first intermediate textile feedstock 304 or second intermediate textile feedstock 311, depending on implementation. In some implementations of these embodiments, the corresponding extraction processes may be performed over multiple (e.g., two or more) iterations or cycles. To this end, whether performed as a single iteration/cycle or multiple iterations/cycles, at each iteration, the input textile feedstock 401 is placed within the vessel 404 along with solvent solution 406 comprising the applicable solvent (at an applicable concentration as noted with respect to method 100 and method 300), and heated (via the heating element 510) to the corresponding target temperature for the batch process implementations, (as discussed with reference to methods 100 and 300) for the corresponding duration of time for the batch process implementations (as discussed with reference to methods 100 and 300), after which the heating is stopped or turned off.

After completion of the heating period, in some implementations the vessel 404 is allowed to cool to a temperature which the reaction solution and the remaining textile feedstock can be handled or transferred (e.g., about 25° C.). The remaining textile feedstock, whether it be the intermediate textile feedstock 104, the purified cellulosic material 112, the first intermediate textile feedstock 304, the second intermediate textile feedstock 311, or the purified cellulosic material 317, depending on implementation, remains as an intact, undissolved fibrous mass and is removed from the vessel 404 by any suitable mechanical means. The solution left behind in vessel 404 corresponds to the applicable mixture produced at that stage of the process (e.g., first mixture 103, second mixture 111, second mixture 310, or third mixture 316) and contains the selectively extracted components in solvated or dispersed form. Each of these mixtures can be subjected to an appropriate separation operation, such as filtration, centrifugation, phase separation, controlled cooling to induce polymer precipitation, antisolvent addition, evaporation of solvent, or pressurized solvent removal, to isolate the extracted material from the solvent and to regenerate the solvent for reuse.

In embodiments in which multiple iterations or extraction cycles are performed for any of the first and/or second extraction processes of method 100 and the first, second and/or third extraction processes of method 300, after completion of each heating period or cycle, the partially processed textile material may be removed from the vessel 404 and rinsed prior to proceeding with the subsequent extraction cycle using a fresh instance of the solvent solution.

In embodiments in which the extracted component comprises disperse colorant, the colorant is typically fully dissolved or molecularly dispersed within the solvent. In embodiments in which the extracted component comprises elastomeric polymers, such polymers may exist as dissolved chains, swollen fragments, or soft particulate residues suspended within the solvent. In some implementations of these embodiments, the remaining mixed textile feedstock (e.g., corresponding to intermediate textile feedstock 104 or second intermediate textile 311, depending on implementation) may be removed from the vessel 404 while hot (e.g., greater than or equal to about 100° C.) and before cooling to the temperature at which the extracted elastomeric polymers form precipitates. In embodiments in which the extracted component comprises polyester, the polyester exists as a true polymer-solvent solution at elevated temperature. In some implementations of these embodiments, the remaining mixed textile feedstock (e.g., corresponding purified cellulose material 117 or purified cellulose material 317, depending on implementation) may be removed from the vessel 404 while hot (e.g., greater than or equal to about 130° C.) and before cooling to the temperature at which the extracted polyester material forms into precipitates.

More particularly, with respect to the second extraction process of method 100 and the third extraction process of method 300, the input textile feedstock 401 corresponds to a poly-cotton blend. During the high-temperature extraction stage, when the polyester-cellulose containing intermediate textile feedstock is contacted with the cyclic ketone solvent at temperatures between about 170° C. and about 210° C., the polyester undergoes complete dissolution. At these temperatures the solvent penetrates and plasticizes the polyester, disrupts chain packing within amorphous and semi-crystalline regions, and produces a homogeneous, low-viscosity polymer-solvent solution in which individual polyester chains are molecularly dispersed and no solid polyester phase remains. The resulting true solution (e.g., second mixture 111 and third mixture 316) contains the solvent and dissolved polyester, optionally with trace polyester oligomers and negligible dye or elastomeric components due to prior extraction steps. Upon cooling the solution to a temperature between about 20° C. and about 120° C., the solubility of the polyester decreases sharply, causing the polyester to precipitate as a solid. The precipitated polyester may be recovered by filtration, decanting, antisolvent addition, or pressure-assisted separation, yielding a purified polyester product that may appear as a fine powder, granules, flakes, or agglomerated particles depending on cooling rate and agitation. In all cases, the recovered polyester (e.g., recovered polyester material 114 and recovered polyester material 319) is free or substantially free of colorants, elastomers, and cellulosic contaminants and is suitable for mechanical reuse or recycling.

In certain embodiments, the polyester extraction step may optionally include a hot-filtration operation to remove insoluble fines or particulate contaminants that may be dispersed in the second mixture 111 or the third mixture 316 prior to polyester precipitation. In this regard, once the polyester has fully dissolved at elevated temperature (e.g., 170-210° C.), prior to precipitating the polyester via cooling, the solution (e.g., the second mixture 111 or third mixture 316), may be transferred through a heated filtration apparatus while maintaining the polymer in the true polymer-solvent solution. Because the polyester is fully solubilized under these conditions, the dissolved polyester and the solutions passes through the filtration apparatus and into a collection vessel, while insoluble materials, such as inorganic pigments, soil particles, titanium dioxide, silica, talc, or other debris that may be present in the mixed textile feedstock 101 and remaining in the second mixture 111 and/or the third mixture 316 are filtered out. The resulting clarified polyester-solvent solution is then cooled to a precipitation temperature, causing the polyester to form solid particulates suitable for recovery by filtration. This hot-filtration approach prevents particulate entrainment within the precipitated polyester and yields a highly purified polymer suitable for downstream glycolysis or thermomechanical recycling.

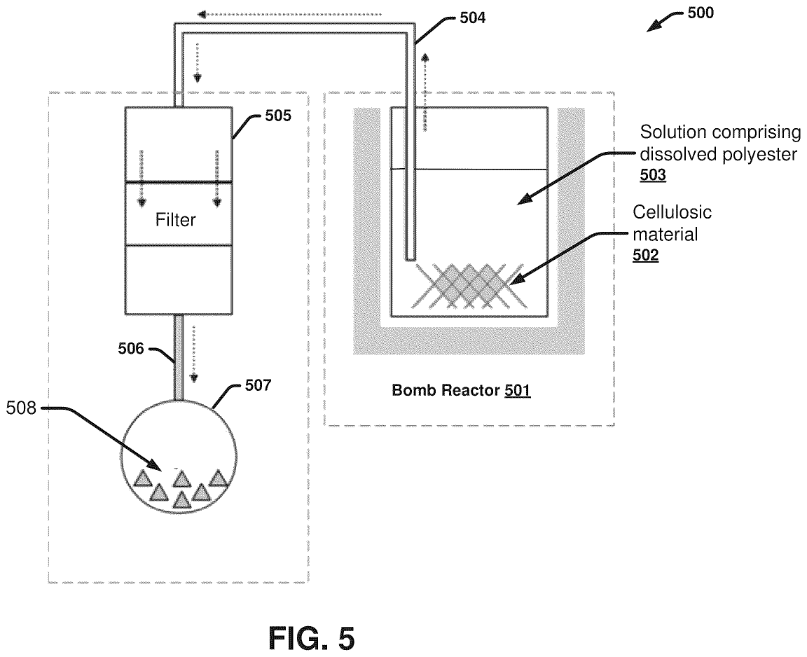

FIG. 5 illustrates an example system 500 for recovering polyester from a high-temperature polyester-solvent solution using an optional hot-filtration and controlled-precipitation operation. As shown, a bomb reactor 501 contains a heated solution 503 comprising dissolved polyester, which corresponds to the second mixture 111 or third mixture 316. Within bomb reactor 501, cellulosic material 502 remains as an insoluble solid held above the bottom of the reactor by a screen or retaining support. The dissolved polyester is therefore present entirely in the solvent phase, while cellulosic material 502 remains physically separated and retained within the reactor during the extraction operation. In some embodiments, multiple extraction cycles may be performed in situ by introducing additional solvent at temperature without opening bomb reactor 501.

A transfer conduit 504 is fluidly coupled to the reactor and permits withdrawal of the hot polyester-containing solution 503 while maintaining the mixture at or above the polyester-solubility temperature (e.g., approximately 170° C.-210° C.). Under these conditions, the polyester remains fully dissolved, preventing premature precipitation or gelation during transfer. The displaced solution enters filtration assembly 505, which includes a filter medium configured to remove insoluble fines that may accompany textile-derived feedstocks. Such fines may include cotton fragments, pigments, titanium dioxide, soil particulates, or other non-dissolved contaminants. Because polyester remains dissolved during this operation, only insoluble solids are retained, and a clarified polyester-solvent solution exits the filtration assembly.

The clarified solution is directed through discharge line 506 into a precipitation chamber 507. Precipitation chamber 507 is configured to reduce the temperature of the clarified solution to a precipitation temperature below the polyester solubility limit (e.g., approximately 20° C.-130° C.). Upon cooling, the dissolved polyester rapidly separates from solution and forms precipitated polyester particulates 508, which may manifest as powders, flakes, granules, or small agglomerates depending on cooling conditions, agitation, or optional antisolvent addition. These particulates may then be isolated from the remaining solvent through filtration, centrifugation, decanting, or other liquid-solid separation techniques to produce a purified polyester fraction suitable for mechanical recycling, melt processing, or chemical depolymerization.

In some embodiments, precipitation chamber 507 may be insulated, temperature-controlled, or equipped with agitation or antisolvent inlets to tailor particle morphology or precipitation kinetics. In all embodiments, performing hot filtration in filtration assembly 505 while the polyester remains in a fully dissolved state helps prevent contamination of precipitated polyester 508 with insoluble fines. This improves the purity, color, and consistency of the recovered polyester relative to recovery approaches lacking such a dissolved-phase filtration step.

In some embodiments, bomb reactor 501 may include a bottom-withdrawal outlet, dip-tube, or drain positioned beneath or adjacent to the retaining support that holds cellulosic material 502. Such a configuration allows solution 503 containing dissolved polyester to be displaced directly from the bottom region of the reactor while the cellulosic material remains physically supported and retained within the chamber. Bottom-withdrawal designs can improve process efficiency by minimizing agitation of the retained solids and by reducing the likelihood of entraining cotton fragments or other insoluble particulates into the transfer conduit 504. In scaled systems, bottom-withdrawal embodiments also allow multiple extraction cycles to be performed sequentially within a sealed reactor at elevated temperatures and pressures, thereby avoiding repeated cooling, depressurization, and reheating steps.

In some embodiments, system 500 may be configured to perform all extraction stages of method 100 or method 300 within a single sealed bomb reactor 501. After loading the mixed textile feedstock 101 and sealing reactor 501, the first extraction process (e.g., selective removal of disperse colorants and elastomeric polymers for method 100, or selective removal of disperse colorants only for method 300) may be carried out at a first temperature. While maintaining the reactor at this temperature, multiple extraction cycles may be performed by withdrawing the dissolved fraction through conduit 504 and introducing fresh solvent without opening the reactor. After completion of the first extraction process, the reactor temperature may be increased to a second temperature to perform the subsequent extraction process (e.g., the second extraction process of method 100 corresponding to the elastomeric-polymer removal, or the second and then third extraction process of method 300), again permitting multiple cycles at the corresponding target temperatures. Throughout this multi-stage sequence, the reactor remains sealed, and the textile material remains inside the reactor 501 until all extraction processes have been completed, thereby transforming the mixed textile feedstock 101 initially input to the reactor into the purified cellulosic material 502.

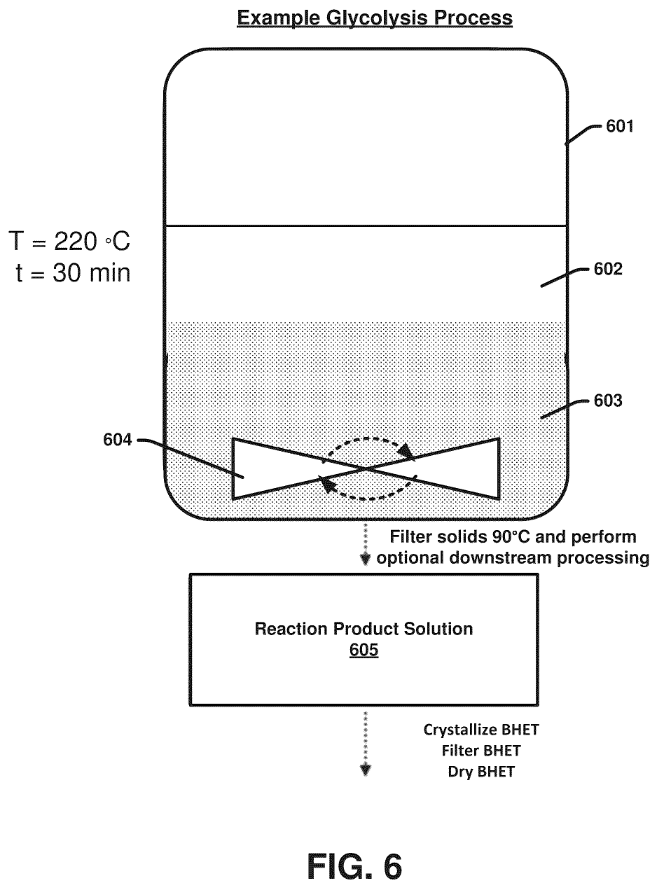

FIG. 6 illustrates an example implementation of a glycolysis process for transforming extracted polyester material 603 into a recycled polyester material, in accordance with one or more embodiments described herein. The extracted polyester material 603 may correspond to recovered polyester material 114 or recovered polyester material 319. In various embodiments, this glycolysis process corresponds to the VolCat process described above. This glycolysis process is applicable to any polyester material that comprises PET. In various embodiments, the extracted polyester material 603 comprises 100% PET. As previously discussed, because the extracted polyester material 603 has been purified via the methods disclosed herein, the extracted polyester material 603 excludes (or substantially excludes) disperse colorant, elastomeric polymers, cellulosic material, and fiber-reactive colorants (as applicable to the cellulosic material in implementations in which the cellulosic material was dyed with fiber-reactive colorants). For example, as described above, as a result of performance of methods 100 or 300 (and optionally the hot-filtration step discussed with reference to FIG. 5) to generate the purified polyester material 603, the purified polyester material 603 has less than 2% mass and more preferably substantially less than 1% mass of the aforementioned components combined (e.g., disperse colorant, elastomeric polymers, cellulosic material, and fiber-reactive colorants).

As a result, the BHET generated from the extracted polyester material 603 via the glycolysis process is a high-purity monomer product exhibiting low color values, low haze, and minimal organic or inorganic residue. In particular, because substantially all colorants and elastomeric contaminants have been removed prior to depolymerization, the BHET produced in this step typically falls within commercial color specifications without the need for extensive post-glycolysis purification, activated-carbon treatment, or ion-exchange processing. Furthermore, the absence of polyurethane, spandex, and other elastomer-derived degradation products prevents the formation of urea-, urethane-, or polyether-derived impurities that otherwise accumulate in BHET when mixed-textile feedstocks are processed without pretreatment. The resulting BHET can therefore be repolymerized to form high-quality recycled PET suitable for use in textile fibers, packaging applications, and other value-added polyester products. In some embodiments, the recycled PET generated from this process exhibits mechanical and optical properties comparable to those of virgin PET due to the high purity of the BHET monomer input.

As illustrated in FIG. 6, the glycolysis process involves placing the extracted polyester material 603 within an optionally pressurized vessel 601 as dissolved within a solvent solution 602 comprising an organocatalyst such as ethylene glycol. The concentration of the extracted polyester material 603 relative to the solvent in the solvent solution 602 is preferably about 1 parts by mass polyester material and 10 parts by mass solvent, more preferably a polyester-solvent ratio of 1:5, and more preferably a polyester-solvent ratio of 1:4. The pressurized vessel 601 may include or correspond to the vessel that is part of a high-pressure batch reactor system (e.g., system 500 or a similar system), such as a Parr high-pressure batch reactor manufactured by the company Parr Instrument Company or a similar high pressure batch reactor, as described with reference to FIG. 4. The pressurized vessel 601 is then heated to a temperature of about 220° C. for a reaction duration of about 30 minutes while stirring via a stir bar 604 (or another mechanical stirring apparatus). This reaction causes the PET of the extracted polyester material 603 to transform into BHET. Thereafter, the pressurized vessel 601 is cooled to around 90° C. or less and any solids (aside from BHET) are filtered out of the reaction mixture, leaving a crude product solution 605 comprising the generated BHET and possibly any residual contaminates (e.g., residual elastomeric polymers, colorants, and/or other contaminants) that may have remained with the purified textile product 603. The BHET is then crystallized and precipitated or filtered out of the crude product solution 605 and dried. As previously discussed, in various embodiments, the recycled polyester material 117 and/or the recycled polyester material 322 may be formed from the BHET via repolymerization thereof.

In an example experimental implementation, a polyester-extraction stage consistent with the second extraction process of method 100 and/or the third extraction process of method 300 was performed using extraction system 400 (or a similar high-pressure batch system). The input feedstock corresponded to polycotton fabric samples containing approximately 50% cotton and 50% PET by mass. These samples included a mixture of reactive, vat, and sulfur dyes, representing major dye classes used across the cotton-textile industry, thereby providing a representative test case for evaluating removal of polyester in the presence of commercially relevant cellulosic colorants. The polyester component of the feedstock was selectively dissolved and removed under the extraction conditions described below, yielding a purified polyester material subsequently subjected to glycolysis to produce BHET. This experimental sequence is referred to herein as Experiment A.

In Experiment A, the polycotton input was combined with a cyclic ketone solvent (e.g., cyclopentanone) and heated under polyester-extraction temperatures disclosed herein (e.g., between about 160° C. and about 220° C.). During heating, the PET component fully dissolved into the solvent phase, while the cotton fibers remained intact and insoluble. After first removing the cotton which is now substantially free of polyester, controlled cooling of the reaction mixture results in the dissolved polyester rapidly precipitating as a PET powder. The cotton fraction, now substantially free of polyester, can be washed with filtered cyclopentanone (or another compatible solvent) to eliminate residual PET. Across all polycotton inputs tested, including those containing mixtures of reactive, vat, direct, and sulfur dyes, this process reproducibly generated PET suitable for downstream depolymerization. An advantage of this workflow is that the bulk cotton fibers are isolated prior to exposure to glycolysis conditions, thereby avoiding contamination of the depolymerization chemistry product with the dye components and byproducts resident on the cotton. Microscopic examination of the recovered cotton using light microscopy confirmed that the fiber morphology and structural integrity were preserved. Maintaining high-quality cotton fibers is beneficial for subsequent mechanical or chemical cellulose-recycling pathways. Any residual coloration on the isolated cotton can be removed using conventional color-removal or bleaching treatments.

In a representative implementation of Experiment A, the following procedure was performed:
1. A 450-mL pressure reactor was charged with 12.5g to 25.0 g of polycotton textile containing PET, along with 250 g of the cyclopentanone as the solvent.
2. The reactor was purged with nitrogen, sealed, and heated to approximately 190° C. for 5 minutes to dissolve the polyester component. The solvent was then removed from the cotton by hot filtration and the solution cooled to room temperature, inducing rapid precipitation of PET as a fine powder.
3. The cooled mixture was filtered to collect the precipitated solids. Filtered cyclopentanone (or another compatible washing solvent) was used to rinse residual PET from the recovered cotton fibers. The isolated cotton and PET powder were each dried to remove remaining traces of cyclopentanone.
4. The dried PET powder was transferred to a second 450-mL pressure reactor and subjected to glycolysis using a PET-to-ethylene glycol mass ratio of 1:4. Approximately 5% by mass weight triethylamine (relative to the original fabric mass) was added as a catalyst. Glycolysis was conducted for 30 minutes at 220° C.
5. After glycolysis, the reaction mixture was cooled to 90° C. and filtered through a ˜1-μm glass-fiber filter to remove insoluble residues (e.g., cotton fines, titanium dioxide).
6. A portion of this solution was cooled to room temperature to precipitate the BHET which was recovered by filtration and dried.
7. The remainder of the reaction mixture at 90° C. was treated with 5% by mass of activated carbon for 30 minutes to remove any colorants remaining in the reaction solution. After filtration to remove the activated carbon half of this was cooled to provide BHET.
8. The remaining reaction mixture at 90° C. was treated with 5% by mass of ion exchange resin for 30 minutes and the BHET recovered as above.

The resulting BHET exhibited high purity due to the absence of disperse colorants, elastomeric polymers, cellulosic material, and fiber-reactive dyes in the extracted polyester starting material. These results demonstrate that the disclosed polyester-extraction processes provide an effective pretreatment for producing high-purity polyester feedstock suitable for glycolysis or other chemical-recycling pathways, even when starting from polycotton materials dyed with chemically diverse classes of cotton dyes.

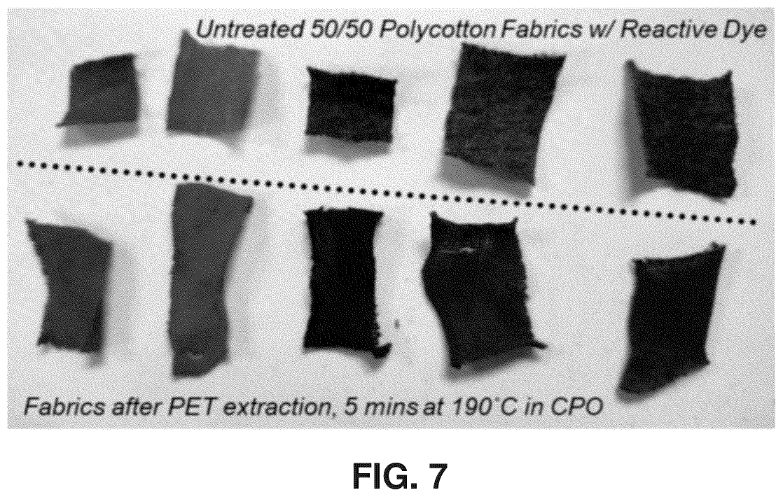

FIG. 7 presents images of representative polycotton fabric samples processed in accordance with Experiment A, shown both before polyester extraction (top row) and after polyester extraction (bottom row). As illustrated in FIG. 7, the untreated 50/50 polycotton fabrics containing reactive dyes exhibit the characteristic hand, thickness, and structural integrity associated with polyester-reinforced cotton blends. Following the PET-extraction stage, the resulting fabrics display a visibly softened, cotton-dominant structure.

The post-extraction samples retain their overall textile geometry and fiber continuity, confirming that the polyester removal step does not cause disintegration or fibrillation of the cotton component. Notably, the isolated cotton fibers preserve the dyed coloration originally imparted by the reactive dyes, consistent with the known insolubility and covalent cellulose bonding behavior of reactive dye classes under the extraction conditions used. The figure demonstrates that the polyester component is selectively removed while the cotton fraction remains intact, mechanically stable, and visually recognizable as the original fabric substrate, a result further supported by microscopic analysis described herein.

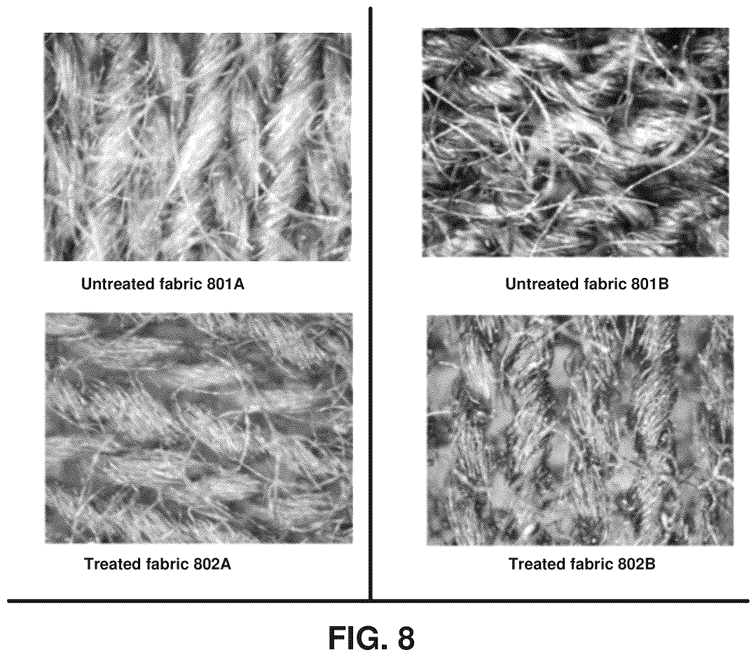

FIG. 8 illustrates light-microscopy images of representative polycotton fabrics before and after polyester extraction in accordance with Experiment A. The images labeled 801A and 801B correspond to untreated 50/50 polycotton fabrics, while the images labeled 802A and 802B (bottom panels) correspond to the same fabrics following polyester removal using the high-temperature cyclic-ketone extraction process described herein.

As shown in FIG. 8, the untreated fabrics (801A, 801B) display the characteristic bicomponent morphology of polycotton blends, in which cotton fibers are interwoven with PET filaments that provide structural reinforcement, sheen, and stiffness. In the untreated state, the PET filaments appear as smooth, continuous, light-reflective strands intermingled with the more irregular, matte, helical cellulose fibers.

Following PET extraction, the corresponding treated fabrics (802A, 802B) exhibit a distinct transition to a cotton-dominant structure. The microscopy images demonstrate that the polyester filaments are absent or substantially absent, confirming selective dissolution and removal of the polyester phase under the extraction conditions. The remaining cotton fibers maintain their longitudinal continuity, fibrillar morphology, and weave pattern without evidence of melting, collapse, or fiber fragmentation. The images also show preservation of twist, surface texture, and fiber-bundle integrity, indicating that the extraction process does not chemically or mechanically degrade the cellulose component.

Notably, the treated cotton retains the coloration imparted by reactive dyes, consistent with the known covalent bonding behavior of reactive dye classes under the extraction conditions. These observations confirm that the process isolates structurally intact, visually recognizable cotton fibers suitable for further reuse, processing, or integration into downstream cellulose-recycling methods.

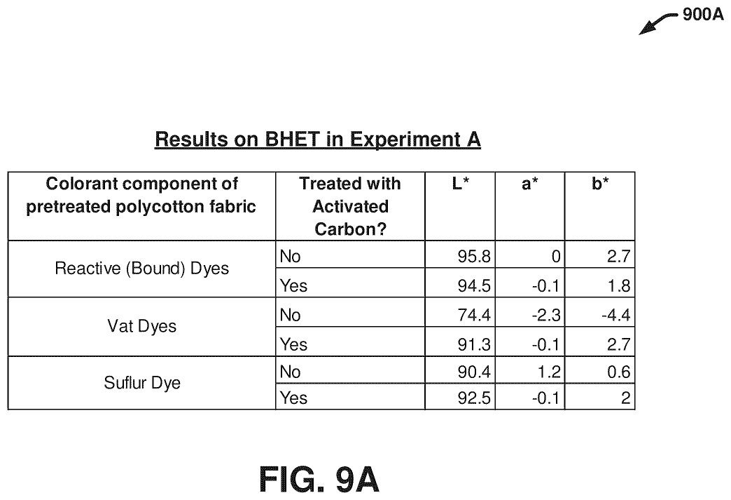

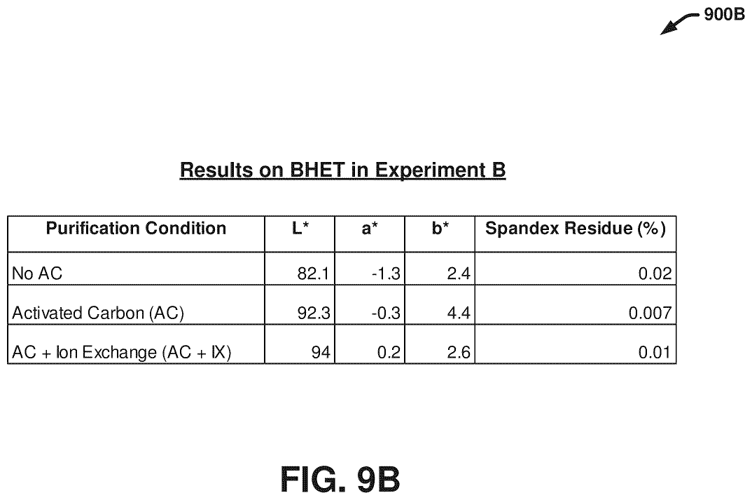

FIG. 9A presents colorimetric data (Table 900A) obtained from BHET produced in accordance with Experiment A, illustrating the effect of dye class and optional activated-carbon treatment on the optical purity of the recovered monomer. The BHET samples were analyzed using the CIE L*a*b* color space, where L* represents lightness on a 0-100 scale (0=black, 100=white), a* represents the red-green axis (positive values indicating red, negative values indicating green), and b* represents the yellow-blue axis (positive values indicating yellow, negative values indicating blue). Lower absolute a* and b* values indicate reduced chromatic deviation, and higher L* values reflect increased whiteness.

As shown in FIG. 9A, BHET derived from polycotton fabrics dyed with reactive dyes and sulfur dyes exhibits high lightness values and very low chromaticity even without activated-carbon treatment. For reactive-dye samples, the untreated BHET displays an L* value of 95.8 with a* and b* values near zero, indicating that the polyester was already highly purified prior to glycolysis. Similarly, sulfur-dye samples yield untreated BHET with L*=90.4 and minimal chromaticity. These results demonstrate that the selective polyester-extraction process disclosed herein effectively removes polyester affinitive dyes during the high-temperature solvent extraction step, leaving only trace chromophores for the glycolysis step to process.

For vat-dye samples, which are known to migrate into polyester and are among the most difficult chromophores to remove, the untreated BHET still exhibits substantial color improvement relative to what would be expected from glycolysis alone. Although vat-derived BHET retains some darker coloration (e.g., L*=74.4), the values indicate that the majority of vat-dye contaminants were already removed by the solvent-extraction pretreatment. Application of activated carbon substantially increases L* (to 91.3) and drives a* and b* values toward zero, confirming that activated carbon can perform effective polishing when the incoming color load is already reduced.

Importantly, these results show that the activated-carbon step is not required to obtain high-purity BHET for reactive-dye and sulfur-dye feedstocks, because the disclosed polyester-extraction process itself produces an already-purified polyester fraction. Activated carbon merely provides an optional refinement step for particularly challenging dye classes such as vat dyes. In chemical-recycling workflows based solely on glycolysis, activated carbon (AC) and ion-exchange (IX) resins can address only limited decolorization demands. In other words, extensive dye contamination cannot be economically remediated by such post-treatment methods alone. The results shown in FIG. 9A therefore underscores a key advantage of the disclosed solvent-extraction pretreatment, as it significantly lowers the dye burden on the glycolysis stage to within the effective operating range of AC and IX polishing, enabling production of high-quality BHET even from heavily dyed polycotton feedstocks.

Another example experimental implementation of the entirety of method 100 was performed using extraction system 400 (or a similar high-pressure batch configuration). In this implementation, the input feedstock corresponded to a mixed textile containing approximately 68% PET, 30% cotton, and 2% spandex by mass. The input feedstock also contained a combination of both disperse colorants and fiber-reactive colorants. This feedstock represents a commercially relevant PET/cellulose/elastomer blend and provides a realistic test case for evaluating selective polyester dissolution and recovery in accordance with method 100. This experimental sequence is referred to herein as Experiment B. In Experiment B, the first extraction process of method 100, (e.g., corresponding to the extraction process at 102 of method 100) and the second extraction process of method 100, (e.g., corresponding to the extraction process at 110 of method 100) were respectively performed over multiple reaction iterations or cycles. The recovered PET was isolated as a solid material and subjected to glycolysis to produce BHET.

In a representative implementation of Experiment B, the following procedure was performed:
1. Sequential Low-Temperature Extractions (at about 140° C.): The PET/cotton/spandex input was subjected to three reaction cycles at approximately 140° C. using cyclopentanone as the solvent to extract disperse colorant and spandex from the input mixed textile feedstock at the amount of about 12.5 g to about 25.0 g. At each extraction cycle the input feedstock was added to a 450-mL pressure reactor along with 250 g of the cyclopentanone. The reactor was purged with nitrogen, sealed, and heated to approximately 140° C. for 5 minutes to extract the disperse colorant and the spandex portion. After each cycle, the fabric was removed, drained, and reintroduced for the next cycle. These cycles produced an intermediate textile feedstock depleted in disperse colorant and spandex yet retaining the cotton and PET components.
2. Sequential High-Temperature Polyester Dissolution (at about 190° C.): The intermediate textile feedstock was then run through two additional extraction cycles at approximately 190° C. At each extraction cycle, a 450-mL pressure reactor was charged with 12.5 g to 25.0 g of the intermediate textile feedstock (e.g., now a polycotton textile containing PET), along with 250 g of the cyclopentanone as the solvent the reactor was purged with nitrogen, sealed, and heated to approximately 190° C. for 5 minutes to dissolve the polyester component. The solvent was then removed from the cotton by hot filtration and the solution cooled to room temperature, inducing rapid precipitation of PET as a fine powder. The cooled mixture was filtered to collect the precipitated solids. Filtered cyclopentanone (or another compatible washing solvent) was used to rinse residual PET from the recovered cotton fibers. The isolated cotton and PET powder were each dried to remove remaining traces of cyclopentanone.
3. Glycolysis and BHET Production: The dried PET powder was transferred to a second 450-mL pressure reactor and subjected to glycolysis using a PET-to-ethylene glycol mass ratio of 1:4. Approximately 5% by mass weight triethylamine (relative to the original fabric mass) was added as a catalyst. Glycolysis was conducted for 30 minutes at 220° C. After glycolysis, the reaction mixture was cooled to 90° C. and filtered through a ˜1-μm glass-fiber filter to remove insoluble residues (e.g., cotton fines, titanium dioxide). A portion of this solution was cooled to room temperature to precipitate the BHET which was recovered by filtration and dried. The remainder of the reaction mixture at 90° C. was treated with 5% by mass of activated carbon for 30 minutes to remove any colorants remaining in the reaction solution. After filtration to remove the activated carbon half of this was cooled to provide BHET. The remaining reaction mixture at 90° C. was treated with 5% by mass of ion exchange resin for 30 minutes and the BHET recovered as above.

The results of Experiment B relative to the BHET products obtained are shown in FIG. 9B and Table 900B. In this regard, Table 900B summarizes the colorimetric and compositional properties of BHET products recovered from PET extracted from the mixed PET/Cotton/Spandex (68/30/2) feedstock following sequential extraction and glycolysis processing in accordance with Experiment B above. Three purification conditions were evaluated, including no activated-carbon treatment (“No AC”), activated-carbon treatment (“AC”), and activated-carbon followed by ion-exchange resin treatment (“AC+IX”).

Under the No AC condition, the recovered BHET exhibited a measured L* value of 82.1, indicating a comparatively darker or more yellow-tinted solid. The corresponding a* (−1.3) and b* (2.4) values reflect a slight greenish and yellowish hue, respectively. The measured spandex-residue content of 0.02% confirms that the upstream polyester-extraction conditions removed the elastomeric fraction to near-complete levels even without further purification of the glycolysis solution.

Treatment with activated carbon (AC) substantially improved the optical properties of the BHET. The L* value increased to 92.3, indicating markedly enhanced brightness and reduced color contamination. The a* and b* values (−0.3 and 4.4, respectively) show that although a slight warm tint remains, the overall chromaticity is significantly improved relative to the untreated solid. The spandex-residue level decreased to 0.007%, demonstrating that activated carbon not only reduces color bodies but also removes trace organic contaminants that may arise from elastomeric additives or dye-associated byproducts.

The AC+IX condition produced the highest-purity BHET. The resulting L* value of 94.0 represents the brightest material evaluated, approaching optical values characteristic of BHET produced from virgin PET feedstocks. The corresponding a* (0.2) and b* (2.6) values indicate a neutral chromatic profile with minimal hue shift. Elastomeric contamination remained extremely low, with a spandex-residue measurement of 0.01%, consistent with the combined ability of activated carbon and ion-exchange resins to remove dye fragments, organic processing aids, catalytic residues, and trace polymeric contaminants from the glycolysis solution.

Overall, these results demonstrate that the polyester-extraction conditions used in Experiment B produce PET that is inherently low in elastomeric contaminants and color bodies, enabling efficient downstream glycolysis. Moreover, optional application of activated carbon and ion-exchange resins can further enhance BHET purity, making the recovered polyester suitable for high-value chemical-recycling pathways, including VolCat or equivalent catalytic repolymerization technologies. The significant increase in L* values and corresponding decrease in measured spandex residue underscores that the disclosed extraction and purification approach effectively removes complex mixtures of disperse dyes, elastomeric polymers, and cotton-associated colorants from post-consumer and post-industrial textile blends.

FIG. 10 illustrates an example continuous flow reaction system (hereinafter system 1000) in accordance with one or more embodiments described herein. With reference to FIG. 10 in view of FIG. 1 and FIGS. 3A-3B, as noted above, in some embodiments, one or more of the extraction processes of methods 100 and 300 may be performed using a continuous flow reaction system, such as system 1000 or a similar system. With these embodiments, the input feedstock 1006 can correspond to mixed textile feedstock 101, intermediate textile feedstock 104, first intermediate textile feedstock 304, or second intermediate textile feedstock 311, depending on the implementation. Likewise, the output product 1008 can correspond to intermediate textile feedstock 104, purified cellulosic material 112, first intermediate textile feedstock 304, second intermediate textile feedstock 311, or purified cellulosic material 317, depending on implementation.

System 1000 includes, but is not limited to, heating element 1001, boiling vessel 1002, condenser 1004, and chamber 1007. The actual implementation of system 1000 can vary with respect to the physical arrangement and size of these components so long as they are respectively connected to one another via suitable conduits (aside from the heating element 1001 which is merely removably coupled to the boiling vessel 1002). In this regard, it should be appreciated that the boiling vessel 1002 is connected to the condenser 1004 via a suitable conduit, the condenser 1004 is connected to the chamber 1007 via a suitable conduit, and the chamber 1007 is connected to the boiling vessel 1002 via a suitable conduit. For example, in some embodiments, system 1000 may include or correspond to a Soxhlet extractor or a variation thereof as adapted for industrial processing of vast amounts of input feedstock 1006.

As indicated via the arrowed lines, FIG. 10 also provides a high-level flow of the extraction process performed using system 1000, (hereinafter, Flow Process 1) in accordance with one or more embodiments. Flow process 1 is performed may be performed in a single-pass, repeatedly, step-wise (as with multiple solvents), or continuously. In this regard, in association with initiation of Flow Process 1, the input feedstock 1006 is placed within the chamber 1007. As described in greater detail below, in some embodiments, this can involve continuously or regularly feeding in input feedstock 1006 into the chamber 1007 (e.g., via a mechanical conveyance or another mechanism), maintaining the input feedstock 1006 therein for the applicable duration of time (as noted with respect to method 100 and method 300) in association with contacting a condensed solvent solution 1005 thereto within the chamber 1007 to extract (at least some of) the target component or components of the input feedstock 1006 therefrom (e.g., either disperse colorant alone, combined disperse colorant and elastomeric polymers, elastomeric polymers alone, or polyester, depending on implementation), thereby transforming the input feedstock 1006 into output product 1008, and removing the output product 1008 from the chamber 1007 after the applicable duration of time (e.g., via mechanical conveyance or another mechanism).

In this regard, over the duration of time in which the input feedstock 1006 is maintained within the chamber 1007, Flow Process 1 comprises repeatedly or continuously heating the boiling vessel 1002 via heating element 1001 to a target temperature (e.g., the solvent's boiling point temperature or higher, depending on implementation) to transform solvent within the boiling vessel 1002 into a vaporized solvent 1003. The (hot) vaporized solvent 1003 travels into the condenser 1004 where it is condensed and transformed into the condensed solvent solution 1005. The condensed solvent solution 1005 is directed into the chamber 1007 where it contacts the input feedstock 1006 therein and extracts or otherwise removes the target component or components from the input feedstock 1006, forming a mixture 1009 comprising the solvent and an extracted amount of the target component or components. For example, depending on implementation, mixture 1009 may correspond to first mixture 103, second mixture 111, first mixture 303, second mixture 310 or third mixture 316. The mixture is 1009 is further directed out of the chamber 1007 and into the boiling vessel 1002. In some embodiments, the mixture 1009 may be directed out of the chamber 1007 and into the boiling vessel 1002 at a controlled rate. For example, the mixture 1009 may be slowly leaked out of the chamber 1007 as new condensed solvent solution 1005 enters the chamber 1007 in a continuous manner. In another implementation, an entirety of the mixture 1009 within the chamber 1007 may be flushed out of the chamber 1007 regularly at a defined rate.

In either implementations, the mixture 1009 is directed out of the chamber 1007 and into the boiling vessel 1002 where it is reheated to transform the solvent therein back into the vaporized solvent 1003, which is again directed to the condenser 1004 where it is transformed into the condensed solvent solution 1005, which is further directed into the extraction chamber 1007 where it extracts additional target material from the input feedstock 1006 contained therein, and forms (additional) mixture 1009, which is then directed into the boiling vessel 1002, and so on. System 1000 and Flow Process 1 thus not only effectively removes the target component or components from the input feedstock 1006 but also reuses the same solvent over and over.

In this regard, Flow Process 1 is performed on continuous loop over the duration of time while the input feedstock 1006 is maintained within the chamber 1007. The duration of time refers to the amount of time the input feedstock 1006 is maintained within the chamber 1007 and exposed to the condensed solvent solution 1005. The duration of time can vary depending on implementation, as discussed with reference to method 100 and 300. The duration of time can also be tailored as a function of the rate of evaporation of the solvent, the rate of condensation of the vaporized solvent, the rate and amount of influx of condensed solvent solution 1005 into the chamber 1007, the size of the chamber, and the like, which can vary based on the architecture of system 1000. Flow Process 1 may also continue to be performed on a continuous loop over sequential durations of time as new input feedstock (e.g., corresponding to input feedstock 1006) is regularly or continuously fed into the chamber 1007 and output product 1008 is regularly or continuously removed from the chamber 1007.

In association with heating the mixture 1009 as included in the boiling vessel 1002, the solvent is vaporized out of the mixture 1009 and transformed into the vaporized solvent 1003 resulting in aggregation of the extracted material 1010 (e.g., disperse colorant, elastomeric polymers, polyester, and/or other components depending on implementation) within the boiling vessel 1002 over time. In various embodiments, the extracted material 1010 can be removed from the boiling vessel, recovered (e.g., via evaporation, precipitation and/or filtration) and reused. The manner and timing at which the extracted material 1010 is removed from the boiling vessel 1002 can vary.

In this regard, Flow Process 1 can be summarized as follows:

### Flow Process 1

1. Placing the input feedstock 1006 in the chamber 1007 of the continuous flow reaction system 1000 for a duration of time.
2. Performing a reaction process over the duration of time using the continuous flow reaction system to transform the input feedstock 1006 into the output product 1008, wherein the reaction process comprises repeatedly or continuously:
   a. contacting a condensed solvent solution 1005 comprising a solvent to the input feedstock 1006;
   b. forming a mixture 1009 comprising the condensed solvent solution and an extracted amount of the target material or materials within the chamber 1007 as a result of the contacting;
   c. collecting the mixture 1009 within the boiling vessel 1002; and
   d. heating the boiling vessel 1002 to transform the solvent within the mixture into the vaporized solvent 1003, wherein the vaporized solvent travels into the condenser and forms the condensed solvent solution 1005; and
   e. directing the condensed solvent solution 1005 into the chamber 1007.
3. Removing the output product 1008 from the chamber 1007 after the duration of time.

In this regard, when using Flow Process 1 and system 1000 as applied to the first and/or second extraction processes of method 100, and/or the first, second and/or third extraction processes of method 300, the “contacting” of the solvent solution corresponds to 2a of Flow Process 1 described above. In other words, the solvent solution described in FIG. 1 and FIGS. 3A-3B corresponds to the condensed solvent solution 1005. To this end, the temperature of the condensed solvent solution 1005 within the chamber 1007 over the duration of the contacting (e.g., or the duration in which the input feedstock 1006 is maintained within the chamber 1007) corresponds to applicable temperatures discussed with respect to the corresponding extraction processes with reference to FIG. 1 and FIGS. 3A and 3B used to selectively remove the corresponding target materials. In addition, the respective durations of time at which the input feedstock 1006 is maintained within the chamber 1007 corresponds to the applicable durations noted with reference to FIG. 1 and FIGS. 3A and 3B. In addition, the solvent-to-feedstock mass ratios described with reference to the continuous flow system implementations of the respective extraction processes described with reference to FIG. 1 and FIGS. 3A and 3B, may correspond to the amount of solvent in the condensed solvent solution within the chamber 1007 relative to the amount of input feedstock 1006 within the chamber 1007. Additionally, or alternatively, the solvent-to-feedstock mass ratios described with reference to the continuous flow system implementations of the respective extraction processes described with reference to FIG. 1 and FIGS. 3A and 3B, correspond to the amount of solvent in the initial solvent solution provided in the boiling vessel prior to initial heating of the boiling vessel 1002.

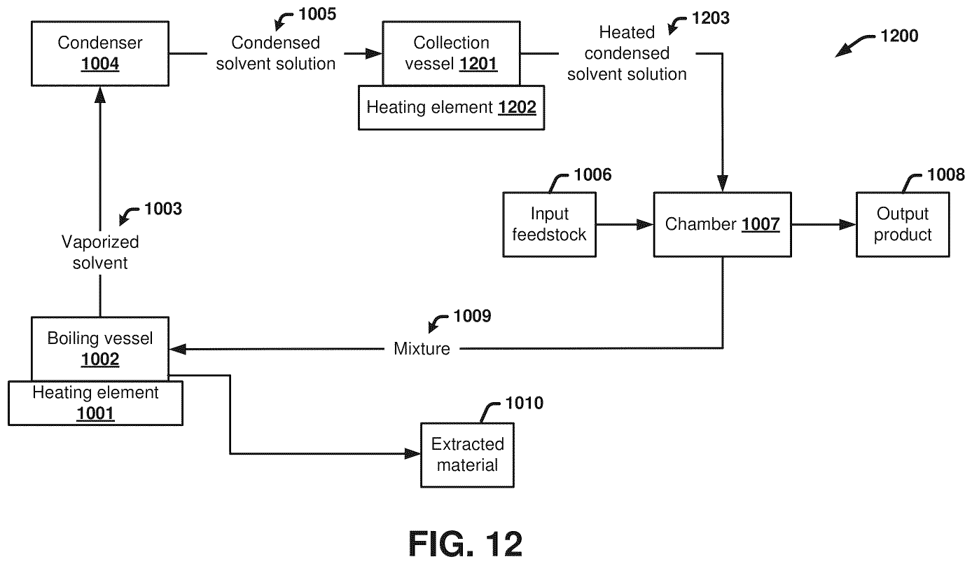

As described with reference to FIG. 1 and FIGS. 3A and 3B, the temperature of the solvent solution, and more particularly in this context, the temperature of the condensed solvent solution 1005, in association with performance of the respective extraction processes of methods 100 and 300 is particularly important and tailored to selectively remove the combination of disperse colorant and elastomeric polymers, selectively remove disperse colorant alone, selectively remove elastomeric polymers alone, or selectively remove polyester alone. In various embodiments, as applied to system 1000, the temperature of the condensed solvent solution 1005 within the chamber 1007 can be controlled to match the applicable target temperatures as a function of the temperature to which the heating element 1001 is set and/or the particular design implementation of the physical components of system 1000. In other embodiments, additional temperature control mechanisms may be implemented with system 1000 to this effect, as described with reference to FIG. 12 and system 1200.

In this regard, because each of the extraction processes of methods 100 and 300 can use the same solvent but achieve selective removal of specific components of the mixed textile feedstock 101 as function of temperature variation, in various embodiments, the entirety of method 100 and/or method 300 may be performed using system 1000 (or modified version thereof discussed below) and sequentially performing the respective first, second and/or third reaction processes without removing the input feedstock 1006 from the chamber 1007 until it is transformed into the purified cellulosic material 112 or the purified cellulosic material 317.

In particular, in an example implementation of method 100 using system 1000 (or a similar system such as system 1200 or system 1300 discussed infra), method 100 can comprise placing the mixed textile feedstock 101 in the chamber 1007 and performing the first extraction process at 102 using a first iteration of Flow Process 1 (or Flow Process 2 discussed infra) to selectively remove all or substantially all of the elastomeric polymers and the disperse colorant therefrom. Over this first iteration of Flow Process 1, the mixed textile feedstock 101 is maintained within the chamber 1007 for an applicable duration of time in association with maintaining the temperature of the condensed solvent solution 1005 in the chamber 1007 at the first temperature (according to the temperature and time conditions specified with reference to FIG. 1 for the continuous flow implementation of the first extraction process of method 100). As a result of this first iteration of Flow Process 1, the mixed textile feedstock 101 in the chamber 1007 is transformed into the intermediate textile feedstock 104 and the mixture 1009 within the boiling vessel 1002 corresponds to the first mixture 103. The heating of the boiling vessel 1002 may be temporarily paused, and the first mixture 103 may be removed from the boiling vessel 1002 to recover the extracted material 1010 (e.g., using applicable mechanisms discussed with reference to FIG. 1), which in this context includes the combination of the extracted disperse colorant and the extracted elastomeric polymers.

Thereafter, the fresh solvent solution can be added to the boiling vessel 1002 and the second extraction process of method 100 at 110 is performed using a second iteration of Flow Process 1 (or Flow Process 2 discussed infra) to selectively remove the polyester component from the intermediate textile feedstock 104 in the chamber 107. Over this second iteration of Flow Process 1, the intermediate textile feedstock 104 is maintained within the chamber 1007 for an applicable duration of time in association with maintaining the temperature of the condensed solvent solution 1005 in the chamber 1007 at the second temperature (according to the temperature and time conditions specified with reference to FIG. 1 for the continuous flow implementation of the second extraction process of method 100). As a result of this second iteration of Flow Process 1, the intermediate textile feedstock 1004 in the chamber 1007 is transformed into the purified cellulosic material 112 and the mixture 1009 within the boiling vessel 1002 corresponds to the second mixture 111. The heating of the boiling vessel 1002 may then be stopped and the second mixture 111 may be removed from the boiling vessel 1002 to recover the extracted material 1010 (using applicable techniques with reference to 113 of method 100 and/or FIG. 5), which in this context includes the polyester material. The purified cellulosic material 112 is then removed from the chamber 1007.

Similarly, in an example implementation of method 300 using system 1000 (or a similar system such as system 1200 or system 1300 discussed infra), method 300 can comprise placing the mixed textile feedstock 101 in the chamber 1007 and performing the first extraction process at 302 using a first iteration of Flow Process 1 (or Flow Process 2 discussed infra) to selectively remove all or substantially all the disperse colorant therefrom. Over this first iteration of Flow Process 1, the mixed textile feedstock 101 is maintained within the chamber 1007 for an applicable duration of time in association with maintaining the temperature of the condensed solvent solution 1005 in the chamber 1007 at the first temperature (according to the temperature and time conditions specified with reference to FIG. 3A for the continuous flow implementation of the first extraction process of method 300). As a result of this first iteration of Flow Process 1, the mixed textile feedstock 101 in the chamber 1007 is transformed into the first intermediate textile feedstock 304 and the mixture 1009 within the boiling vessel 1002 corresponds to the first mixture 303. The heating of the boiling vessel 1002 may be temporarily paused, and the first mixture 303 may be removed from the boiling vessel 1002 to recover the extracted material 1010 (e.g., using applicable mechanisms discussed with reference to FIG. 1), which in this context includes the disperse colorant (and other additive substances discussed herein when included in the mixed textile feedstock 101).

Thereafter, the fresh solvent solution can be added to the boiling vessel 1002 and the second extraction process of method 300 at 309 is performed using a second iteration of Flow Process 1 (or Flow Process 2 discussed infra) to selectively remove the elastomeric polymers from the first intermediate textile feedstock 304 as maintained in the chamber 107. Over this second iteration of Flow Process 1, the first intermediate textile feedstock 304 is maintained within the chamber 1007 for an applicable duration of time in association with maintaining the temperature of the condensed solvent solution 1005 in the chamber 1007 at the second temperature (according to the temperature and time conditions specified with reference to FIG. 3A for the continuous flow implementation of the second extraction process of method 300). As a result of this second iteration of Flow Process 1, the first intermediate textile feedstock 1004 in the chamber 1007 is transformed into the second intermediate textile feedstock 3111 and the mixture 1009 within the boiling vessel 1002 corresponds to the second mixture 310. The heating of the boiling vessel 1002 may then be stopped and the second mixture 310 may be removed from the boiling vessel 1002 to recover the extracted material 1010 (using applicable techniques with reference to 312 of method 300), which in this context includes the elastomeric polymers.

Thereafter, the fresh solvent solution can be added to the boiling vessel 1002 and the third extraction process of method 300 at 315 is performed using a third iteration of Flow Process 1 (or Flow Process 2 discussed infra) to selectively remove the polyester material from the second intermediate textile feedstock 311 in the chamber 107. Over this second iteration of Flow Process 1, the second intermediate textile feedstock 311 is maintained within the chamber 1007 for an applicable duration of time in association with maintaining the temperature of the condensed solvent solution 1005 in the chamber 1007 at the third temperature (according to the temperature and time conditions specified with reference to FIG. 3B for the continuous flow implementation of the third extraction process of method 300). As a result of this third iteration of Flow Process 1, the second intermediate textile feedstock 311 in the chamber 1007 is transformed into the purified cellulosic material 317 and the mixture 1009 within the boiling vessel 1002 corresponds to the third mixture 316. The heating of the boiling vessel 1002 may then be stopped and the third mixture 316 may be removed from the boiling vessel 1002 to recover the extracted material 1010 (using applicable techniques with reference to 318 of method 300 and/or FIG. 5), which in this context includes the polyester material. The purified cellulosic material 317 is then removed from the chamber 1007.

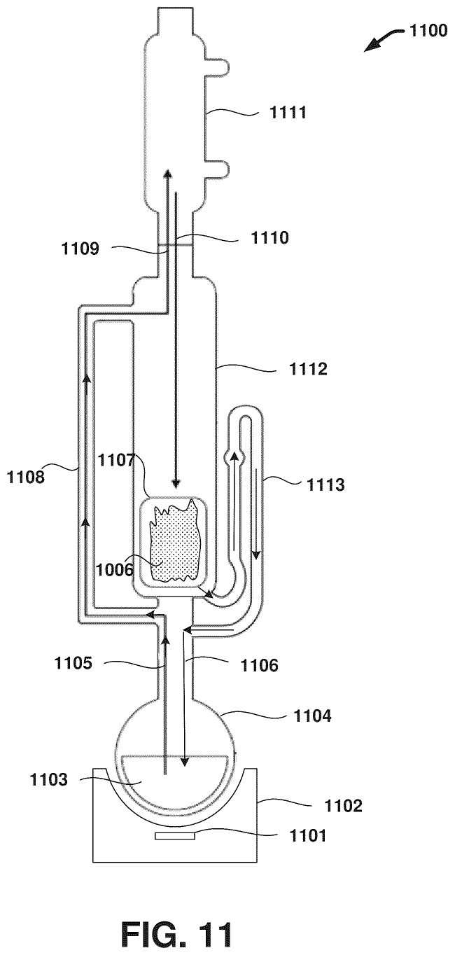

FIG. 11 illustrates another example continuous flow reaction system (hereinafter system 1100) in accordance with one or more embodiments described herein. System 1100 corresponds to an embodiment of system 1000. In accordance with this embodiment, system 1100 includes or corresponds to a Soxhlet extraction system.

System 1100 includes a boiling vessel 1104 (e.g., corresponding to boiling vessel 1002), a condenser 1111 (e.g., corresponding to condenser 1004), a side arm 1108 connecting the boiling vessel 1104 to the condenser 1111, a chamber 1112 (e.g., corresponding to chamber 1007), a siphon arm 1113 connecting the chamber 1112 to the boiling vessel 1104, and a heating element 1102 positioned below the boiling vessel 1104 (e.g., corresponding to heating element 1001).

Upon initial operation, (fresh) solvent solution 1103 (comprising one or more of the disclosed solvents) is placed in the solvent boiling vessel 1104, and the input feedstock 1006 is placed in the chamber 1112. In some embodiments, the chamber 1112 can include removable a thimble 1107 or basket formed of a porous, heat-resistant material, which holds the input feedstock 1006 and allows hot, condensed solvent solution to pass therethrough. The solvent solution 1103 in the boiling vessel 1104 is heated at least to the solvent boiling point temperature in order to vaporize the solvent via the heating element 1102. In other embodiments, the solvent solution 1103 in the boiling vessel 1104 is heated to a higher temperature than the solvent boiling point. In this manner the temperature of the condensed solvent solution 1105 can be controlled to the target temperatures discussed herein when it enters the chamber 1112. The heating element 1102 can include a thermocouple 1101 to monitor and/or control the temperature to which the solvent solution 1103 is heated. In some embodiments, another thermocouple may be integrated on or within the chamber 1112 to detect the temperature of the condensed solvent solution therein.

Once the solvent has vaporized, the solvent vapor travels from the boiling vessel 1104 to the condenser 1111 via the side arm 1108, as indicated via arrows 1105 and 1109. In this regard, it should be appreciated that a first opening is provided between the boing vessel 1104 and the side arm 1108 that connects the boiling vessel 1104 to the side arm 1108, and a second opening is further provided between the side arm 1108 and the condenser 1111 that connects the side arm 1108 to the condenser 1111.

Within the condenser 1111, the vapor (e.g., vaporized solvent 1003) condenses into a liquid (e.g., condensed solvent solution 1005, also referred to as “condensed solvent” or “condensate”) that drips from the condenser 1111 into the chamber 1112 via gravity (as indicated via arrow 1110). In this regard, it should be appreciated that a third opening is provided between the condenser 1111 and the chamber 1112 that connects the condenser 1111 to the chamber 1112. The condensed solvent solution thus slowly fills the chamber 1112 where it contacts the input feedstock 1006 and extracts (some of) the elastomeric polymers and/or colorant and forms a mixture with condensed solvent solution (e.g., mixture 1009 comprising solvent and the extracted material 1010). The mixture is further directed back into the boiling vessel 1104 via the siphon arm 1113 automatically at a rate controlled as a function of the siphon level and reflux rate of the siphon arm 1113 (as indicated via arrow 1106). In some implementations, the amount of the condensed solvent solution relative to the amount of the input feedstock 1006 maintained within the chamber 1112 over the reaction process is about 1 part by mass to about 10 parts by mass.

In various embodiments, the evaporation-condensation-extraction is repeated in a continuous loop for a duration of time until the input feedstock 1106 is free of disperse colorant, elastomeric polymers, and/or polyester, depending on implementation. In addition, the mixed solvent solution remaining in the solvent boiling vessel 1104 can be reused until such time that the residue is recovered by evaporation and/or filtration to separate the solvent from the extracted material (e.g., colorant and/or elastomeric polymers) where the former may be reused in additional solvent extractions and the latter may be reused in downstream applications.

FIG. 12 illustrates another example continuous flow reaction system (hereinafter system 1200) in accordance with one or more embodiments described herein. System 1200 corresponds to system 1000 as modified to increase efficiency. Repetitive description of like elements employed in respective embodiments is omitted for sake of brevity. In accordance with this embodiment, system 1200 includes a collection vessel 1201 and another heating element 1202 positioned between the condenser 1004 and the chamber 1007. The collection vessel 1201 collects the condensed solvent solution 1005 which is heated therein by the heating element 1202 to an increased temperature, thereby transforming the condensed solvent solution 1005 into heated condensed solvent solution 1203 which is directed into the chamber 1007. In other words, in some embodiments, the condensed solvent solution 1205 may be heated prior to being directed into the chamber 1007. Additionally, or alternatively, the chamber 1007 may be heated via another heating element (not shown), to increase the temperature of the condensed solvent solution therein to the applicable target temperatures for the selective removal of materials as discussed herein. In either of these embodiments, the temperature of the heated condensed solvent solution 1203 is increased relative to the temperature of the condensed solvent solution 1005, which enables precise control of the target temperature for extraction and increases extraction efficiency (e.g., in terms of reducing contact time or exposure duration between the input feedstock 1006 and the condensed solvent solution 1005). In this regard, although the solvent solution is heated in the boiling vessel 1002 via heating element 1001, after it evaporates and condenses via the condenser 1004, the temperature of the resulting condensed solvent solution 1005 decreases. For example, assuming the solvent vapor leaves the boiling vessel 1002 at or near its boiling point temperature, the temperature of the condensed solvent solution 1005 becomes lower than the boiling point temperature owing to the condensing operation.

In this regard, as opposed to Flow Process 1 and extraction system 1000, in other embodiments, the one or more of the extraction processes of method 100 and/or method 300 may be performed using system 1200 and a modified version of Flow Process 1, hereinafter referred to as Flow Process 2. Flow Process 2 is the same as Flow Process 1, except for the modification that the condensed solvent solution 1005 is heated to the target extraction temperature (and thus transformed into heated condensed solvent solution 1203) prior to introduction into the chamber 1007. Additionally, or alternatively, Flow Process 2 modifies Flow Process 1 by heating the chamber 1007 and thus the condensed solvent solution 1005 therein to the target temperature. As noted throughout, the target temperature can correspond to the applicable temperatures discussed with reference to FIG. 1 and FIGS. 3A-3B, depending on implementation.

In another embodiment, instead of the chamber 1007 being a static chamber, the chamber 1007 may include a mechanical conveyance apparatus (hereinafter referred to as a “conveyor”), such as an auger, screw, internal or external helix or spiral, paddle or belt screw, helix, spiral, paddle or belt which moves the input feedstock 1006 into and through the chamber 1007 and removes the output product 1008 out of the chamber following completion of the extraction process. In some embodiments, the heated condensed solvent solution 1203 (or the condensed solvent solution 1005) may be gravity fed into the chamber 1007. In another embodiment, the heated condensed solvent solution 1203 (or the condensed solvent solution 1005) may may be pumped into the chamber 1007 (e.g., using any suitable solvent pump). For example, the heated condensed solvent solution 1203 (or the condensed solvent solution 1005) be pumped into the chamber 1007 in a counter-current flow compared to the flow of the conveyed input feedstock 1006. In all embodiments, the temperature and feed rates of the heated condensed solvent solution 1203 (or the condensed solvent solution 1005) and the input feedstock 1006 should be balanced so that the residence time of the input feedstock 1006 within the chamber 1007 is sufficient for maximum and selective extraction of the desired material components.

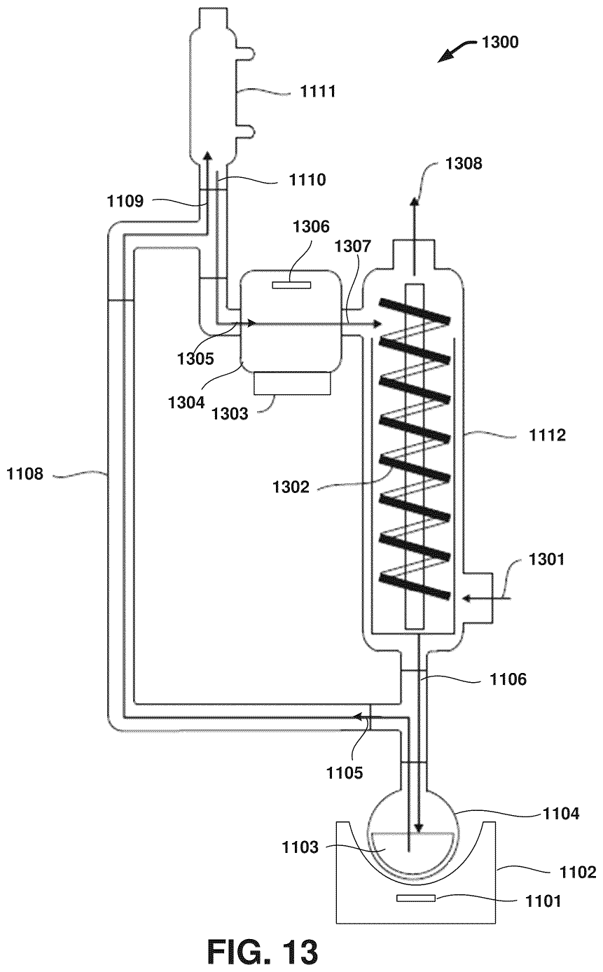

In this regard, FIG. 13 illustrates another example continuous flow reaction system (hereinafter system 1300) in accordance with one or more embodiments described herein. System 1300 corresponds to an embodiment of system 1200. System 1300 is similar to system 1100 yet modified to increase extraction efficiency as described above. Repetitive description of like elements employed in respective embodiments is omitted for sake of brevity.

In accordance with this embodiment, chamber 1112 includes an inlet opening 1301 via which input feedstock 1006 may be fed into the chamber 1112 and an outlet opening 1308 via which reacted or output product 1008 may be removed from the chamber 1112. In some implementations, the input feedstock 1006 may be manually fed into the inlet opening 1301. In other implementations, another mechanical conveyance apparatus may be used to feed the input feedstock 1006 into the inlet opening 1301. The chamber 1112 also includes a conveyor 1302 (such as an auger, screw, internal or external helix or spiral, paddle, belt or another mechanical conveyance apparatus) that conveys the feedstock material in a countercurrent direction (relative to the flow of the heated condensed solvent solution 1203 in into the chamber as illustrated) through the chamber 1112 and carries it out through the outlet opening 1308 once the desired amount of target material has been selectively removed therefrom. With this embodiment, new (unreacted) input feedstock 1006 may be continuously fed into the chamber 1112 as the output product 1008 is removed therefrom, optionally over the duration of the reaction process.

System 1300 also includes a collection vessel 1304 (e.g., corresponding to collection vessel 1201) positioned between the condenser 1111 and the chamber 1112, and a heating element 1303 (corresponding to heating element 1202) coupled to the collection vessel 1304. In operation, the condensed solvent solution (e.g., condensed solvent solution 1005) flows from the condenser 1111 into the collection vessel 1304 (as indicated via arrow 1305) where it is heated via heating element 1303, and then out of the collection vessel 1304 and into the chamber 1112 (as indicated via arrow 1307). In some implementations, a solvent pump may be integrated on or within the collection vessel 1304 to pump the heated condensed solvent solution out of the collection vessel and into the chamber 1112. A thermocouple 1306 may also be integrated on or within the collection vessel 1304 to control and monitor the temperature of the heated, condensed solvent solution.

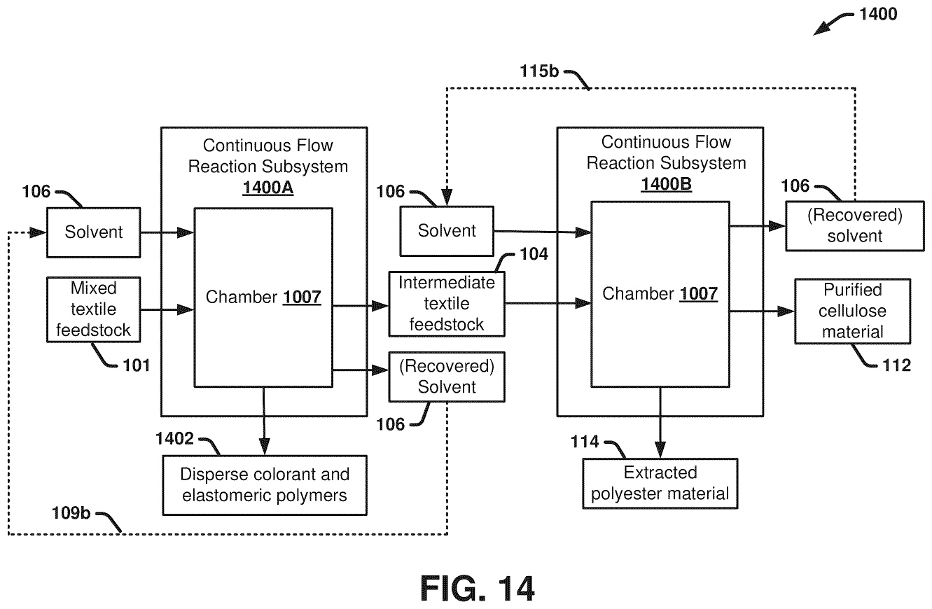

FIG. 14 illustrates another example continuous flow reaction system (hereinafter, system 1400), in accordance with one or more embodiments described herein. System 1400 includes two continuous flow reaction subsystems, respectively referred to a continuous flow reaction subsystem 1400A and continuous flow reaction subsystem 1400B. In some embodiments, each of continuous flow reaction subsystems 1400A and 1400B correspond to system 1000 and/or system 1100. In other embodiments, each of continuous flow reaction subsystems 1400A and 1400B correspond to system 1200 and/or system 1300. For ease of illustration, aside from the chamber 1007, the additional components of continuous flow reaction subsystems 1400A and 1400B have been removed from FIG. 14. Repetitive description of like elements employed in respective embodiments is omitted for sake of brevity.

In various embodiments, system 1400 can be used for the performance of method 100. With these embodiments, the first extraction process of method 100 at 102 may be performed using continuous flow reaction subsystem 1400A and the second extraction process of method 100 at 110 may be performed using continuous flow reaction subsystem 1400B.

In accordance with performance of method 100 using system 1400, the mixed textile feedstock 101 is fed (preferably via mechanical conveyance) into chamber 1007 of continuous flow reaction subsystem 1400A where the first extraction process is performed in accordance with Flow Process 1 or Flow Process 2, resulting in transformation of the mixed textile feedstock 101 into intermediate textile feedstock 104. As illustrated, the input to continuous flow reaction subsystem 1400A also includes the solvent 106 (e.g., in solution form and at an applicable solvent-to-feedstock concentration ratio), which may be continuously recovered and reused by the continuous flow reaction subsystem 1400A, as indicated via dashed arrowed line 109b and previously described. The output of continuous flow reaction subsystem 1400A also includes the extracted material 1402, which in this context includes the combination of disperse colorant and elastomeric polymers 1402.

The intermediate textile feedstock 104 is then removed from chamber 1007 of continuous flow reaction subsystem 1400A (preferably via mechanical conveyance) and fed into chamber 1007 of continuous flow reaction subsystem 1400B (preferably via mechanical conveyance) where the second extraction process of method 100 is performed, resulting transformation of the intermediate textile feedstock 104 into the purified cellulosic material 112. As illustrated, the input to continuous flow reaction subsystem 1400B also includes the solvent 106 (e.g., in solution form and at an applicable solvent-to-feedstock concentration ratio), which may be continuously recovered and reused by the continuous flow reaction subsystem 1400B, as indicated via dashed arrowed line 115b and previously described. The output of continuous flow reaction subsystem 1400B also includes the extracted material, which in this context includes the recovered polyester material 114.

With the configuration illustrated in FIG. 14, system 1400 can be operated as a continuous-flow processing platform that receives an incoming stream of mixed textile feedstock 101 and, over extended operating periods (e.g., hours, days, or weeks), continuously generates a corresponding output stream of purified cellulosic material 112. Continuous flow reaction subsystem 1400A continuously extracts disperse colorants and elastomeric polymers from the mixed textile feedstock 101 to produce an intermediate textile feedstock 104 and an isolated stream of extracted material 1402. The intermediate textile feedstock 104 is then continuously delivered to continuous flow reaction subsystem 1400B, which extracts polyester material therefrom and yields an isolated stream of recovered polyester material 114 together with the purified cellulose material 112.

In certain implementations, the same solvent stream 106 can be circulated and reused across both continuous flow reaction subsystems 1400A and 1400B for successive extraction cycles applied to newly introduced portions of mixed textile feedstock 101. Such solvent recirculation can substantially reduce solvent consumption, operational costs, and waste generation while maintaining extraction efficacy. Accordingly, system 1400 is particularly well suited for industrial-scale processing of large volumes of mixed textile feedstock in accordance with the disclosed methods, enabling selective removal of disperse colorants, elastomeric polymers, and polyester material while continuously producing purified cellulose material in isolated form.

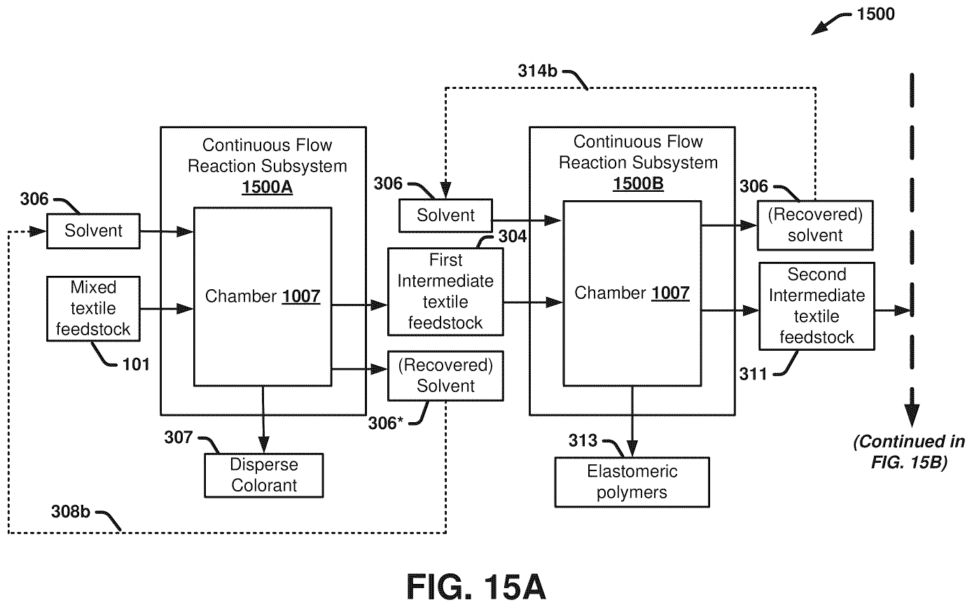

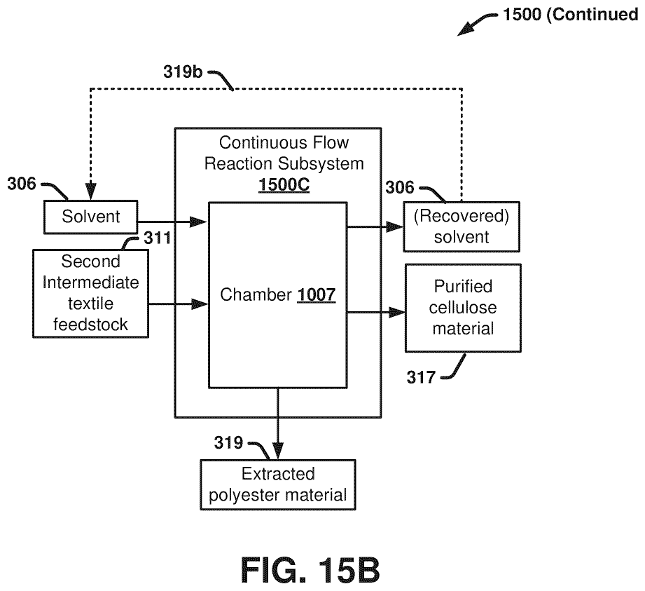

FIGS. 15A and 15B illustrates another example continuous flow reaction system (hereinafter, system 1500), in accordance with one or more embodiments described herein. System 1500 is similar to system 1400 yet includes three continuous flow reaction subsystems, respectively referred to a continuous flow reaction subsystem 1500A, continuous flow reaction subsystem 1500B, and continuous flow reaction subsystem 1400C. In some embodiments, each of continuous flow reaction subsystems 1500A, 1500B and 1500B correspond to system 1000 and/or system 1100. In other embodiments, each of continuous flow reaction subsystems 1500A, 1500B and 1500C correspond to system 1200 and/or system 1300. For ease of illustration, aside from the chamber 1007, the additional components of continuous flow reaction subsystems 1500A, 1500B and 1500C have been removed from FIG. 15. Repetitive description of like elements employed in respective embodiments is omitted for sake of brevity.

In various embodiments, system 1500 can be used for the performance of method 300. With these embodiments, the first extraction process of method 300 at 302 may be performed using continuous flow reaction subsystem 1500A, the second extraction process of method 300 at 309 may be performed using continuous flow reaction subsystem 1500B, and the third extraction process of method 300 at 315 may be performed using continuous flow reaction subsystem 1500C.

In accordance with performance of method 300 using system 1500, the mixed textile feedstock 101 is fed (preferably via mechanical conveyance) into chamber 1007 of continuous flow reaction subsystem 1500A where the first extraction process is performed in accordance with Flow Process 1 or Flow Process 2, resulting in transformation of the mixed textile feedstock 101 into intermediate textile feedstock 304. As illustrated, the input to continuous flow reaction subsystem 1500A also includes the solvent 306 (e.g., in solution form and at an applicable solvent-to-feedstock concentration ratio), which may be continuously recovered and reused by the continuous flow reaction subsystem 1500A, as indicated via dashed arrowed line 308b and previously described. The output of continuous flow reaction subsystem 1500B also includes the extracted material, which in this context includes the disperse colorant 307 (and other additive components discussed herein when included in the mixed textile feedstock 101).

The first intermediate textile feedstock 304 is then removed from chamber 1007 of continuous flow reaction subsystem 1500A (preferably via mechanical conveyance) and fed into chamber 1007 of continuous flow reaction subsystem 1500B (preferably via mechanical conveyance) where the second extraction process of method 300 is performed, resulting transformation of the firs intermediate textile feedstock 304 into the second intermediate textile feedstock 311. As illustrated, the input to continuous flow reaction subsystem 1500B also includes the solvent 306 (e.g., in solution form and at an applicable solvent-to-feedstock concentration ratio), which may be continuously recovered and reused by continuous flow reaction subsystem 1500B, as indicated via dashed arrowed line 314b and previously described. The output of continuous flow reaction subsystem 1500B also includes the extracted material, which in this context includes the elastomeric polymers 313.

Continuing to FIG. 15B, the second intermediate textile feedstock 311 is then removed from chamber 1007 of continuous flow reaction subsystem 1500B (preferably via mechanical conveyance) and fed into chamber 1007 of continuous flow reaction subsystem 1500C (preferably via mechanical conveyance) where the third extraction process of method 300 is performed, resulting transformation of the second intermediate textile feedstock 304 into the purified cellulosic material 317. As illustrated, the input to continuous flow reaction subsystem 1500C also includes the solvent 306 (e.g., in solution form and at an applicable solvent-to-feedstock concentration ratio), which may be continuously recovered and reused by the continuous flow reaction subsystem 1500C, as indicated via dashed arrowed line 319b and previously described. The output of continuous flow reaction subsystem 1500C also includes the extracted material, which in this context includes the recovered polyester material 319.

With the configuration illustrated in FIGS. 15A and 15B, system 1500 can be operated as a continuous-flow processing platform that receives an incoming stream of mixed textile feedstock 101 and, over extended operating periods (e.g., hours, days, or weeks), and continuously generates a corresponding output stream of purified cellulosic material 317. Continuous flow reaction subsystem 1500A continuously extracts disperse colorants from the mixed textile feedstock 101 to produce the first intermediate textile feedstock 304 and an isolated stream of extracted disperse colorant 307. The first intermediate textile feedstock 304 is then continuously delivered to continuous flow reaction subsystem 1500B, which extracts the elastomeric polymer material therefrom and yields an isolated stream of elastomeric polymers 313 together with the second intermediate textile feedstock 311. The second intermediate textile feedstock 311 is then continuously delivered to continuous flow reaction subsystem 1500C, which extracts polyester material therefrom and yields an isolated stream of recovered polyester material 319 together with the purified cellulose material 317.

In certain implementations, the same solvent stream 306 can be circulated and reused across each of continuous flow reaction subsystems 1500A, 1500B and 1500B for successive extraction cycles applied to newly introduced portions of mixed textile feedstock 101. Such solvent recirculation can substantially reduce solvent consumption, operational costs, and waste generation while maintaining extraction efficacy. Accordingly, system 1500 is particularly well suited for industrial-scale processing of large volumes of mixed textile feedstock in accordance with the disclosed methods, enabling selective removal of disperse colorants, elastomeric polymers, and polyester material while continuously producing purified cellulose material in isolated form.

### Additional Experiments 1-10

In example experimental implementation of the first extraction process of method 100 using system 1100 or a similar system (e.g., a Soxhlet extraction system), various disperse dyes (e.g., those shown in FIG. 2 and others), elastomeric polymers (e.g., spandex and TPE) and other additive components were removed from mixed fabric samples component, some colored and some white. These experiments are referred to as Experiments 1-8 and described below. In addition, batch procedures using a high-pressure batch reactor (e.g., Parr high-pressure batch reactor manufactured by the company Parr Instrument Company) were conducted on both white and black spandex mixed fabric to remove spandex. These Experiments are referred to as Experiments 9 and 10 and described below.

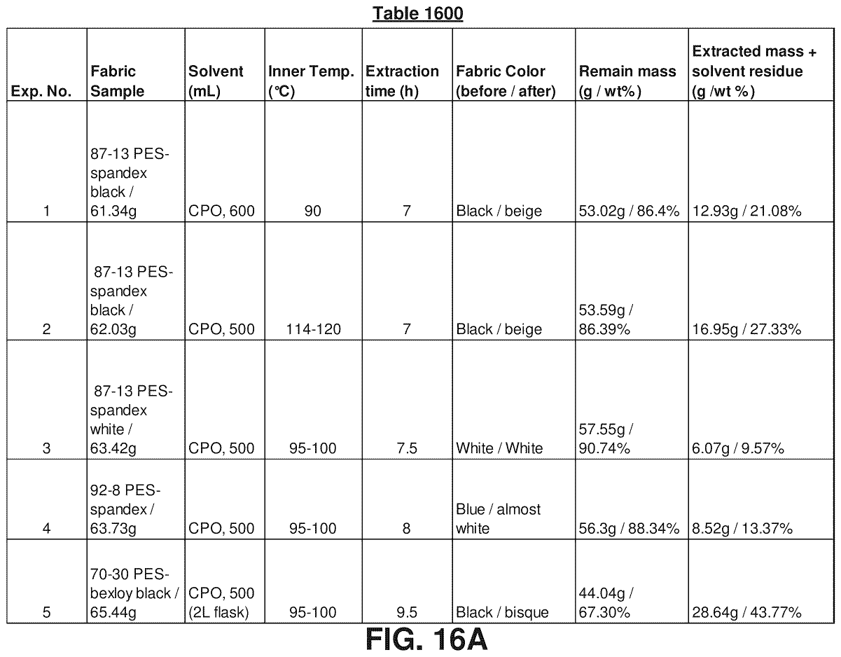

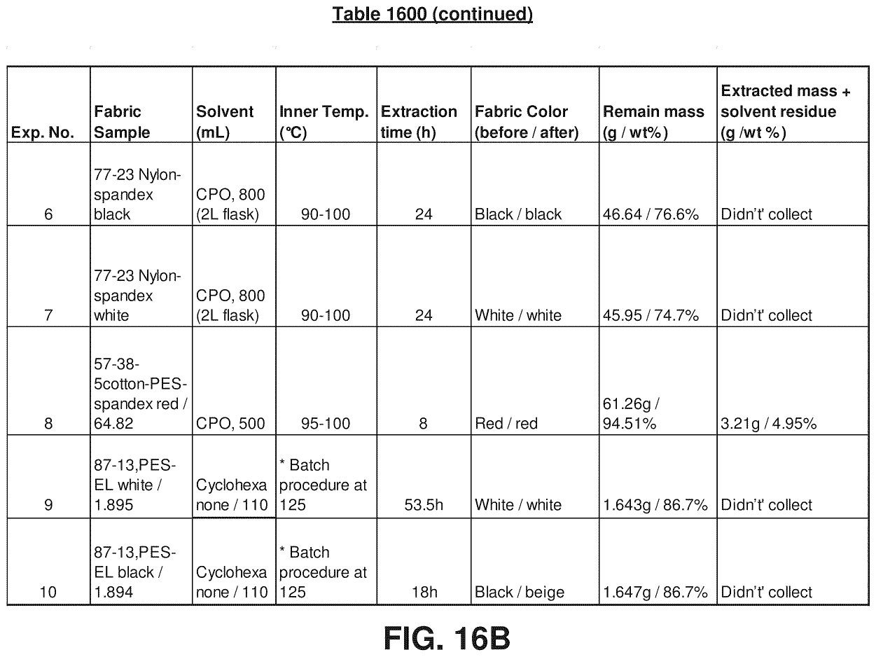

Materials: FIGS. 16A and 16B presents a table (Table 1600) identifying the respective fabric samples used for each of Experiments 1-10. All fabric samples included elastomeric polymers in the form of spandex and/or TPE. Some of the fabric samples were also dyed with a disperse dye (e.g., blacks, blue, and red) and others were white to begin with (e.g., the samples used for Experiments 3, 7 and 9, as indicated in Table 1600. Cyclopentanone was used as the solvent for Experiments 1-8 while cyclohexanone was used as the solvent for Experiments 9 and 10.

Each of Experiments 1-8 were performed separately for the corresponding fabric samples indicated in Table 1600 using system 1100 (or a similar system) with boiling vessels of varying sizes to accommodate the indicated solvent solution amounts (e.g., ranging from 500 milliliters (mL) to 800 mL, as indicated in Tables 1600. The respective fabric samples were placed in a thimble and situated therein to assure the sample remained below the refluxed liquid level during extraction. The thimble was then loaded into the chamber and the condenser was attached with a thermocouple in the chamber to detect the temperature of the condensed solvent solution therein (referred to as the inner temperature). The chamber 1112 was covered with glass wool for thermal insulation. The indicated amount of fresh solvent solution was added to the boiling vessel, which was also equipped with a magnetic stir bar. The heating mantle was then placed under the boiling vessel with a thermocouple embedded between for temperature control (referred to herein as the outer temperature). The heating mantel was then heated for the duration of the extraction times indicated in Table 1600 (which ranged between 7 hours and 24 hours). The inner temperatures of Experiments 1-8 are also indicated in Table 1600, which ranged between 90° C. and about 120° C. After this time the heating was removed and the fabric was removed from the apparatus and dried in a vacuum oven at 70-75° C.

Extraction Process of Experiments 9 and 10: Each of Experiments 9 and 10 were performed separately for the corresponding fabric samples indicated in Table 1600 using a high-pressure batch reactor (e.g., corresponding to system 400). These reactions were respectively carried out of convenience for 53.5 hours and 18 hours at a temperature of 125° C.

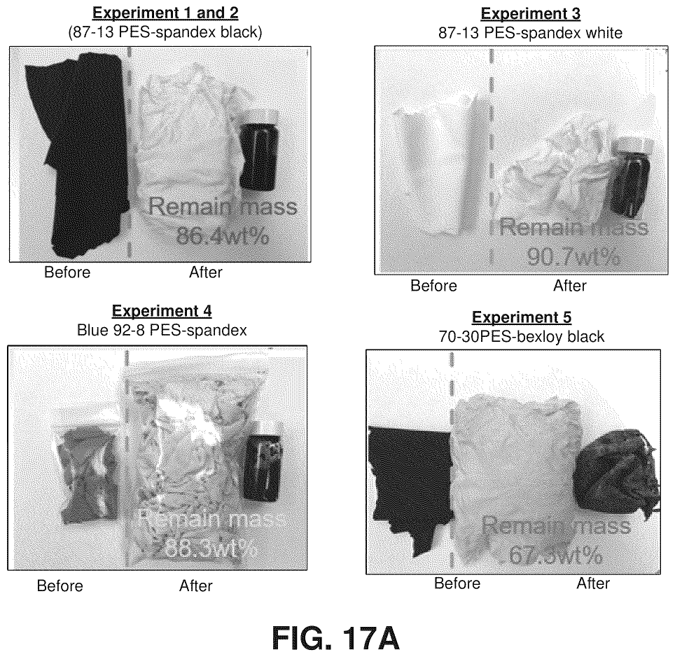

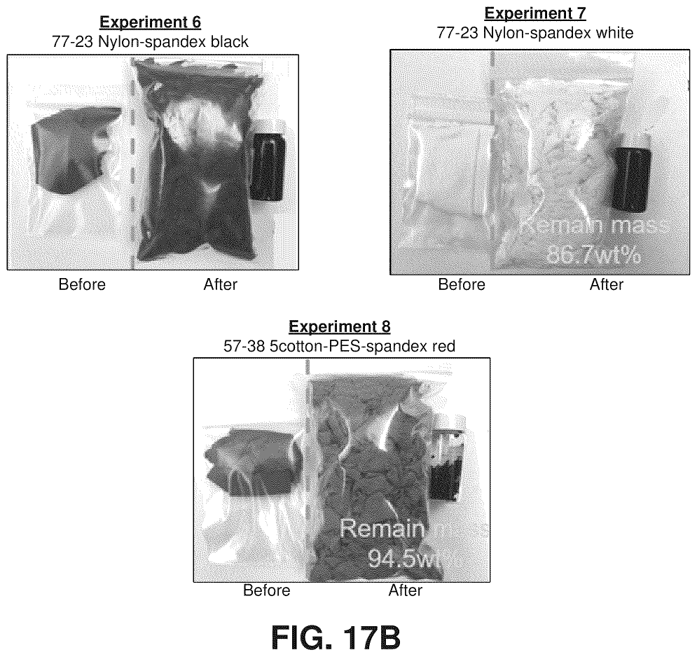

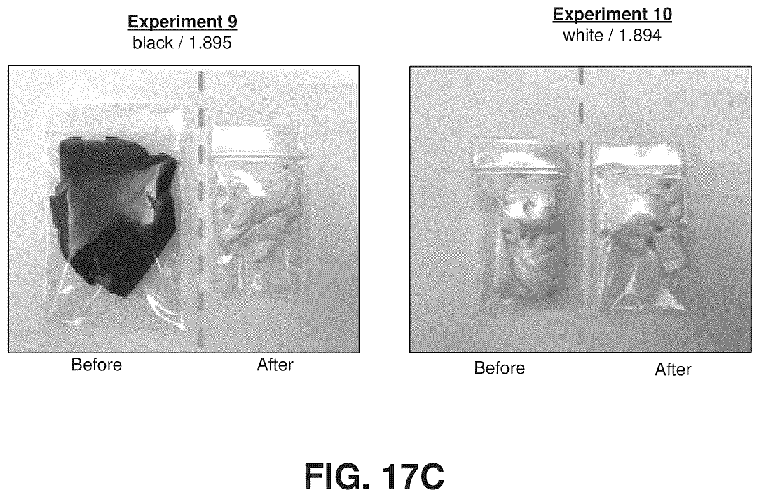

Results: The results of experiments 1-10 are summarized in Table 1600. In addition, FIGS. 17A-17C present images of the respective fabric samples used in Experiments 1-10 before and after extraction.

As indicated in Table 1600, for Experiments 1-8, which were performed using cyclopentanone solvent under continuous reflux conditions, substantial removal of elastomeric polymers and disperse colorants was observed across all tested fabric types. In Experiment 1 (87-13 PES-spandex black), the fabric transitioned from black to beige following 7 hours of extraction at an outer temperature of 385° C. and inner temperature of 90° C., with the remaining fabric mass reduced to 53.02 g (86.4 wt %) and the extracted mass (including solvent residue) measured at 12.93 g (21.08 wt %). Experiment 2, performed on a similar PES-spandex black sample but at a higher outer temperature of 405° C. and an inner temperature of 114-120° C., produced a comparable bleaching outcome (black to beige) and a similar remaining mass of 53.59 g (86.39 wt %), with 16.95 g (27.33 wt %) removed.

Experiment 3 (PES-spandex white) demonstrated that the solvent system does not appreciably affect undyed polyester fibers, as the sample remained white before and after extraction, with 57.55 g (90.74 wt %) of mass remaining and 6.07 g (9.57 wt %) removed. Similarly, Experiment 4 (92-8 PES-spandex blue) produced a marked color change from blue to almost white, with 56.3 g (88.34 wt %) remaining and 8.52 g (13.37 wt %) extracted.

Experiment 5 (70-30 PES-bexley black) resulted in a substantial discoloration from black to bisque following 9.5 hours of extraction and exhibited a more pronounced mass loss relative to other samples, with 44.04 g (67.30 wt %) remaining and 28.64 g (43.77 wt %) removed. Experiments 6 and 7 (77-23 nylon-spandex blends) showed removal of elastomeric polymers while preserving the nylon fiber color: Experiment 6 (black) remained black, and Experiment 7 (white) remained white after extraction. These samples retained 46.64 g (76.6 wt %) and 45.95 g (74.7 wt %), respectively. The extracted mass from these nylon-based samples was not collected due to experimental constraints.

Experiment 8 (57-38-5 cotton-polyester-spandex red) also demonstrated selective extraction behavior. The fabric remained red following 8 hours of cyclopentanone extraction; however, a measurable mass loss of 3.21 g (4.95 wt %) occurred, reflecting removal of elastomeric and additive components incorporated within the polyester fraction.

Experiments 9 and 10 were performed in a high-pressure batch reactor using cyclohexanone solvent at 125° C. to remove elastomeric polymers from white and black PES-EL blends. Experiment 9 (white) remained white before and after extraction, with 1.643 g (86.7 wt %) of mass retained. Experiment 10 (black) changed from black to beige under the same conditions and retained 1.647 g (86.7 wt %). In both cases the extracted mass was not collected, but the observed mass loss and color changes confirm removal of spandex and associated additives.

Across all experiments, the data demonstrate that the first extraction process of method 100 effectively removes elastomeric polymers and disperse colorants from a wide range of polyester-blend fabric compositions while preserving the integrity and color of non-dyed or dye-insensitive fibers such as nylon and cotton. The observed mass reductions, in combination with significant color changes in dyed samples, confirm that the cyclic ketone solvent system consistently penetrates and extracts elastomeric components and disperse colorants under the tested conditions.

As illustrated in FIGS. 17A-17C, for most of the Experiments involving fabric samples dyed with disperse dye (e.g., Experiments 1, 2, 4, 5 and 9), the colorant was entirely or substantially removed. As indicated in Table 1600, for each of Experiments 1-10, a significant amount of mass (reflected in the remaining mass of the treated fabric) of extracted material was removed from all samples. The extracted material included both colorant and elastomeric polymers.

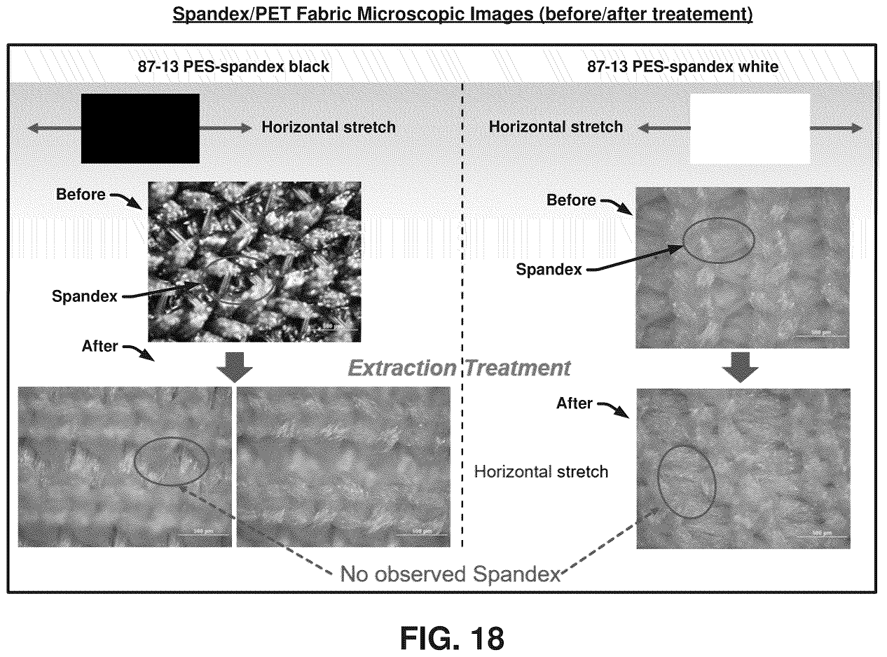

FIG. 18 presents microscopic images of the fabric samples used in Experiments 9 and 10 while being stretched horizontally. As shown in FIG. 18, no spandex was observed in the respective fabric samples following the batch extraction processes using cyclohexanone.

The herein disclosure describes non-limiting examples. For ease of description or explanation, various portions of the herein disclosure utilize the term “each,” “every,” or “all” when discussing various examples. Such usages of the term “each,” “every,” or “all” are non-limiting. In other words, when the herein disclosure provides a description that is applied to “each,” “every,” or “all” of some particular object or component, it should be understood that this is a non-limiting example, and it should be further understood that, in various other examples, it can be the case that such description applies to fewer than “each,” “every,” or “all” of that particular object or component.

The Experimental examples described herein (e.g., Experiments A and 1-10) are set forth to provide those of ordinary skill in the art with a complete disclosure of how to make and use the aspects and embodiments of the invention as set forth herein. While efforts have been made to ensure accuracy with respect to variables such as amounts, temperature, etc., experimental error and deviations should be considered. Unless indicated otherwise, parts are parts by weight, temperature is degrees centigrade, and pressure is at or near atmospheric, or can be elevated relative to the boiling point and vapor pressure of a given solvent and the desired extraction temperature. All components were obtained commercially unless otherwise indicated.

The descriptions of the various embodiments have been presented for purposes of illustration, but are not intended to be exhaustive or limited to the embodiments disclosed. Many modifications and variations will be apparent without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for separating components of a mixed textile feedstock, wherein the mixed textile feedstock comprises a disperse colorant, a polyester material, elastomeric polymers and a cellulosic material, the method comprising:
extracting at least some of the disperse colorant and at least some of the elastomeric polymers from the mixed textile feedstock using a first extraction process, resulting in an intermediate textile feedstock that excludes the at least some of the disperse colorant and the at least some of the elastomeric polymers and retains the polyester material and the cellulosic material, wherein the first extraction process comprises contacting the mixed textile feedstock to a solution comprising a solvent in association with heating the solution to a first temperature, and wherein the solvent is selected from the group consisting of a ketone and an ether; and
extracting at least some of the polyester material from the intermediate textile feedstock using a second extraction process, resulting in a purified cellulosic material that excludes the at least some of the polyester material, the at least some of the disperse colorant and the at least some of the elastomeric polymers, wherein the second extraction process comprises contacting the intermediate textile feedstock to the solution in association with heating the solution to a second temperature higher than the first temperature.

2. The method of claim 1, wherein the solvent comprises cyclopentanone, cyclohexanone, diphenyl ether, or a combination thereof.

3. The method of claim 1, wherein the first temperature is between about 120 degrees Celsius and about 160 degrees Celsius, and wherein the second temperature is greater than or equal to about 160 degrees Celsius.

4. The method of claim 1, wherein a first duration of the contacting of the first extraction process is between about 1 minute and about 20 minutes, and a second duration of the contacting of the second extraction process is between about 1 minute and about 20 minutes.

5. The method of claim 1, wherein the disperse colorant is selected from the group consisting of, a disperse dye, a pigment, and an optical brightener.

6. The method of claim 1, wherein the cellulosic material comprises cotton.

7. The method of claim 1, wherein the solution comprises a solvent-to-feedstock mass ratio between about 5:1 and about 50:1.

8. The method of claim 1, wherein contacting the intermediate textile feedstock to the second solution at the second temperature dissolves the at least some of the polyester material into the solution to form a mixture comprising the at least some of the polyester material, and wherein the method further comprises:
removing the purified cellulosic material from the solution; and
cooling the mixture to a precipitation temperature between about 20 degrees Celsius and about 130 degrees Celsius, thereby precipitating the at least some of the polyester material to form a precipitated polyester material.

9. The method of claim 8, further comprising:
transforming the precipitated polyester material into a recycled polyester material via a recycling process.

10. The method of claim 9, wherein the precipitated polyester material comprises polyethylene terephthalate (PET), and wherein the recycling process comprises transforming the PET into Bis(2-hydroxyethyl)terephthalate (BHET) using glycolysis, and repolymerizing the BHET to form the recycled polyester material.

11. A method for separating components of a mixed textile feedstock, wherein the mixed textile feedstock comprises a disperse colorant, elastomeric polymers, a polyester material, and a cellulosic material, the method comprising:
extracting at least some of the disperse colorant from the mixed textile feedstock using a first extraction process resulting in a first intermediate textile feedstock that excludes the at least some of the disperse colorant and retains the elastomeric polymers, the polyester material and the cellulosic material, wherein the first extraction process comprises contacting the mixed textile feedstock to a solution comprising a solvent in association with heating the solution to a first temperature, and wherein the solvent is selected from the group consisting of a ketone and an ether;
extracting at least some of the elastomeric polymers from the first intermediate textile using a second extraction process, resulting in a second intermediate textile feedstock that excludes the at least some of the elastomeric polymers and retains the polyester material and the cellulosic material, wherein the second extraction process comprises contacting the first intermediate textile feedstock to the solution in association with heating the solution to a second temperature higher than the first temperature; and
extracting at least some of the polyester material from the second intermediate textile feedstock using a third extraction process, resulting in a purified cellulosic material that excludes the at least some of the polyester material, the at least some of the disperse colorant and the at least some of the elastomeric polymers, wherein the third extraction process comprises contacting the second intermediate textile feedstock to the solution in association with heating the solution to a third temperature higher than the second temperature.

12. The method of claim 11, wherein the solvent comprises cyclopentanone, cyclohexanone, diphenyl ether, or a combination thereof.

13. The method of claim 11, wherein the first temperature is between about 50 degrees Celsius and about 110 degrees Celsius, wherein the second temperature is between about 110 degrees Celsius and about 160 degrees Celsius, and wherein the third temperature is greater than or equal to 160 degrees Celsius.

14. The method of claim 11, wherein a first duration of the contacting of the first extraction process is between about 1 minute and about 20 minutes, a second duration of the contacting of the second extraction process is between about 1 minute and about 20 minutes, and a third duration of the contacting of the third extraction process is between about 1 minute and about 10 minutes.

15. The method of claim 11, wherein the cellulosic material comprises cotton, and wherein the disperse colorant is selected from the group consisting of, a disperse dye, a pigment, and an optical brightener.

16. The method of claim 11, wherein the solution comprises a solvent-to-feedstock mass ratio between about 5:1 and about 50:1.

17. The method of claim 11, wherein contacting the second intermediate textile feedstock to the solution at the third temperature dissolves the at least some of the polyester material into the solution to form a mixture comprising the at least some of the polyester material, and wherein the method further comprises:
removing the purified cellulosic material from the solution; and
cooling the mixture to a precipitation temperature between about 20 degrees Celsius and about 130 degrees Celsius, thereby precipitating the at least some of the polyester material to form a precipitated polyester material.

18. The method of claim 11, further comprising:
transforming the precipitated polyester material into a recycled polyester material via a recycling process.

19. A method for separating components of a mixed textile feedstock, wherein the mixed textile feedstock comprises elastomeric polymers, a polyester material, and a cellulosic material, the method comprising:
extracting at least some of the elastomeric polymers from the mixed textile feedstock using a first extraction process, resulting in an intermediate textile feedstock that excludes the at least some of the elastomeric polymers and retains the polyester material and the cellulosic material, wherein the first extraction process comprises contacting the mixed textile feedstock to a solution comprising a solvent in association with heating the solution to a first temperature, and wherein the solvent is selected from the group consisting of a ketone and an ether; and
extracting at least some of the polyester material from the intermediate textile feedstock using a second extraction process, wherein the second extraction process comprises contacting the intermediate textile feedstock to the solution in association with heating the solution to a second temperature greater than the first temperature.

20. The method of claim 19, wherein the solvent comprises cyclopentanone, cyclohexanone, diphenyl ether, or a combination thereof.

21. The method of claim 19, wherein the first temperature is between about 120 degrees Celsius and about 160 degrees Celsius, and wherein the second temperature is greater than or equal to about 160 degrees Celsius.

22. The method of claim 19, wherein a first duration of the contacting of the first extraction process is between about 1 minute and about 20 minutes, and a second duration of the contacting of the second extraction process is between about 1 minute and about 20 minutes.

23. The method of claim 19, wherein the solution comprises a solvent-to-feedstock mass ratio between about 5:1 and about 50:1.

24. The method of claim 19, wherein contacting the intermediate textile feedstock to the solution at the second temperature dissolves the at least some of the polyester material into the solution to form a mixture comprising the at least some of the polyester material, and wherein the method further comprises:
removing the purified cellulosic material from the solution; and
cooling the mixture to a precipitation temperature between about 20 degrees Celsius and about 130 degrees Celsius, thereby precipitating the at least some of the polyester material to form a precipitated polyester material.

25. The method of claim 24, further comprising:
transforming the precipitated polyester material into a recycled polyester material via a recycling process; and
transforming the purified cellulosic material into a recycled cellulosic material via another recycling process.
